(19) United States
(12) Patent Application Publication
(10) Pub. No.: US 2012/0210967 A1
(43) Pub. Date: Aug. 23, 2012

(54) ANAEROBIC DEFLAGRATION INTERNAL PISTON ENGINES, ANAEROBIC FUELS AND VEHICLES COMPROSING THE SAME

(76) Inventor: Joshua WALDHORN, Kfar Shmariyahu (IL)

(21) Appl. No.: 13/369,344

(22) Filed: Feb. 9, 2012

Related U.S. Application Data
(62) Division of application No. 12/278,896, filed on Aug. 8, 2008.

(30) Foreign Application Priority Data
Feb. 9, 2006 (IL) 173635

(51) Int. Cl. F02B 75/00

(52) U.S. Cl. 123/1 A

(57) ABSTRACT

The present invention depicts a reciprocating engine actuated by means of anaerobic fuel comprising a piston reversibly actuated inside a cylinder in an N-stroke operation, the piston being in communication with a crank; a feeding means adapted to introduce the anaerobic fuel to a cylinder head accommodating at least one piston and cylinder, in at least one event of each of said N-stroke; an ignition means igniting the anaerobic fuel in or adjacent to the cylinder head, whereat the piston is in at least one predetermined location in the cylinder along each of the N-strokes, so that in each stroke, a predetermined deflagration of the anaerobic fuel is actuating the crank.

### FIELD OF THE INVENTION

The present invention generally relates to anaerobic deflagration internal piston engines, anaerobic fuels, vehicles comprising the same and methods thereof.

### BACKGROUND OF THE INVENTION

The commercially available internal piston engine is a heat engine in which combustion of a fuel occurs in a confined space and creates high temperature/pressure gases, which are permitted to expand. The expanding gases are used to directly move a piston, turbine blades, rotor(s), or the engine itself thus doing useful work.

Reference is made to FIG. 1, presenting the parts of a commercially available four-stroke engine. Key parts of the engine include the crankshaft, one or more camshafts, and valves. FIG. 1 shows inter alia piston (181), piston rod (182), crosshead (183), connecting rod (184), and crank (185). For a two-stroke engine, there may simply be an exhaust outlet and fuel inlet instead of a valve system. In both types of engines, there are one or more cylinders and for each cylinder there is a spark plug, a piston and a crank. A single sweep of the cylinder by the piston in an upward or downward motion is known as a stroke and the downward stroke that occurs directly after the air-fuel mix in the cylinder is ignited is known as a power stroke.

All internal combustion engines depend on the exothermic chemical process of combustion: the reaction of a fuel, typically with air, although other oxidizers, such as nitrous oxide are sometimes employed. The most common fuels in use today are made up of hydrocarbons and are derived from petroleum. These include the fuels known as gasoline, liquefied petroleum gas, vaporized petroleum gas, compressed natural gas, natural petroleum gas, hydrogen, diesel fuel, JP18 (jet fuel), landfill gas, bio-diesels, peanut oil, ethanol, and methanol (methyl or wood alcohol). The combustion of those hydrocarbons produces carbon dioxide, a major cause of global warming, as well as carbon monoxide, resulting from incomplete combustion.

Other limitations on fuels are that the fuel must be easily transportable through the fuel system to the combustion chamber, and that the fuel release sufficient energy in the form of heat and pressurized gas upon combustion to make use of the engine workable.

The maximal efficiency of commercially available internal combustion engines does not usually exceed more than 51% percent.

The oxidizer is typically air, but can be pure oxygen, nitrous oxide, hydrogen peroxide or mixtures thereof. Other chemicals such as chlorine or fluorine have seen experimental use.

Diesel engines are generally heavier, noisier and more powerful at lower speeds than gasoline engines. They are also more fuel-efficient in most circumstances and are used in heavy road-vehicles, some automobiles (increasingly more so for their increased fuel-efficiency over gasoline engines), ships and some locomotives and light aircraft. Gasoline engines are used in most other road-vehicles including most cars, motorcycles and mopeds. Both gasoline and diesel engines produce significant emissions. There are also engines that run inter alia on hydrogen, methanol, ethanol, liquefied petroleum gas (LPG) and liquefied natural gas (LNG) and bio-diesel.

Many approaches have been taken to produce more power, namely increasing displacement, increasing the compression ratio, using turbo chargers, cooling the incoming air, letting air come in more easily, and under pressure, letting exhaust fumes exit more easily, making the moving components lighter, injecting the fuel in atomized form, etc. However all of these approaches suffer from the fundamental limitation that they require an external source of oxidizer that is provided separately from the fuel. Imperial patent specification German patent 305,967 is related to the combustion or firing of surplus ammunition stocks in combustion chambers. Similarly, U.S. Pat. No. 3,527,050 discloses a solid fuel and oxidizer for underwater use, but this patent utilizes separate fuel and oxidizer streams. Therefore, an AIP (anaerobic internal piston) and anaerobic deflagration driven reciprocating internal combustion piston engine and an utilizable safe fuel combining fuel and oxidizer for the same is still a long felt need.

### SUMMARY OF THE INVENTION

It is an object of the present invention to disclose a reciprocating engine, comprising (a) at least one piston, said at least one piston adapted for reversible actuation in an N-stroke operation, where N is a positive integer; (b) at least one cylinder adapted to accommodate said at least one piston; (c) a crank in mechanical communication with said piston; (d) a cylinder head adapted to accommodate said at least one piston and cylinder; (e) feeding means adapted to introduce fuel to said cylinder head at least once per piston stroke; and (f) ignition means adapted to ignite said fuel in or adjacent to said cylinder head when said at least one piston is substantially in at least one predetermined location in said cylinder along each of said N strokes. It is in the essence of the invention wherein said fuel is an anaerobic fuel and further wherein said piston is actuated by the pressure of gas produced by predetermined deflagration of said anaerobic fuel.

It is a further object of this invention to disclose the reciprocating engine as described above, wherein said reciprocating engine additionally comprises controlling means, adapted to control the timing of said ignition according to a predetermined time protocol.

It is a further object of this invention to disclose the reciprocating engine as described above, wherein the controlling means are selected from the group consisting of electronic means, mechanical means, hydraulic means, pneumatic means, sensors e.g., light sensor, pressure sensor, temperature sensor, chemical sensor, electronic sensors; valves, gages, solenoids, detectors, smoke detectors, processing means, real time based CPUs, displaying means, alarms, feed-backing means, recording means, transmitters, and any combination thereof.

It is a further object of this invention to disclose the reciprocating engine as described above, wherein N=2.

It is a further object of this invention to disclose the reciprocating engine as described above, wherein N=4.

It is a further object of this invention to disclose the reciprocating engine as described above, wherein the igniting means are selected from a group consisting of heating plugs, sparkplugs, electron beams, lasers, visible light emitters, UV light emitters, IR light emitters, acoustic emitters, vibration emitters, radiation emitters, mechanical firing-pins or cocks, pressure inducing means, shock wave inducers, detonators, fire, heating means or heat wave emitters, oxidizers, acids, oils, mineral salts, igniting means in the gaseous, liquid or solid state, means for emission of a magnetic field, shim inducers, or any combination thereof.

It is a further object of this invention to disclose the reciprocating engine as described above, wherein the engine type is selected from a group consisting of a rotary engine, horizontal engine, V-shaped, a line-shaped, star shaped, or engines with “H”, “U”, “X”, or “W” configurations.

It is a further object of this invention to disclose the reciprocating engine as described above, wherein said cylinder head comprises at least one deflagration chamber, said at least one deflagration chamber adapted to accommodate at least a portion of said anaerobic fuel.

It is a further object of this invention to disclose the reciprocating engine as described above, wherein said deflagration chamber is located within said reciprocating engine cylinder head.

It is a further object of this invention to disclose the reciprocating engine as described above, wherein said deflagration chamber is located adjacent to said reciprocating engine cylinder head.

It is a further object of this invention to disclose the reciprocating engine as described above, wherein said deflagration chamber is located outside of said cylinder head, and further wherein said deflagration chamber is in fluid communication with said cylinder head, said fluid communication means adapted to direct the flow of said gas produced by said predetermined deflagration from said deflagration chamber into said cylinder head.

It is a further object of this invention to disclose the reciprocating engine as described above, wherein said igniting means provides at least 2 ignitions per piston stroke.

It is a further object of this invention to disclose the reciprocating engine as described above, wherein said engine additionally comprises fluid communicating means adapted to direct exhaust gas from said reciprocating engine to at least one auxiliary chosen from the group consisting of a turbine, a heat exchanger, or a generator.

It is a further object of this invention to disclose the reciprocating engine as described above, wherein the outer surface of said piston is at least partially made of materials selected from the group consisting of ceramic materials, metallic alloys, hard carbon, composite materials, ceramic plastics, sintered ceramic with beryllium or plastics matrices, fine or nano-particles of ceramics, metals, and any combination thereof.

It is a further object of this invention to disclose the reciprocating engine as described above, wherein the outer surface of said cylinder is at least partially made of a substance chosen from the group consisting of ceramic materials, metallic alloys, composite materials, hard carbon, ceramic plastics, sintered ceramic with beryllium or plastic matrices, fine or nano-particles of ceramics, metals, and any combination thereof.

It is a further object of this invention to disclose the reciprocating engine as described above, wherein the piston cylinder comprises a plurality of rings, especially pressure rings, lubricating rings, piston positioning direction rings, and further wherein at least one ring is at least partially made of materials selected from the group consisting of ceramic materials, metallic alloys, composite materials, ceramic plastics, sintered ceramic with beryllium, plastics matrices, commercially available Okolon combined materials, fine or nano-particles of ceramics with particle diameter of especially 0.1 to 1 μm, metals, and any combination thereof.

It is a further object of this invention to disclose an anaerobic fuel for reciprocating engines, said fuel selected from the group consisting of compositions of sulfur, ammonium nitrate, ammonium picrate, aluminum powder, potassium chlorate, potassium nitrate (saltpeter), nitrocellulose, nitroglycerin pentaerythiotol tetranitrate (PETN), CGDN, 2,4,6 trinitrophenyl methylamine(tetryl) and any other booster propellants and or any other types of explosives, a mixture containing (a) about 97.5% RDX, (b) about 1.5% calcium stearate, (c) about 0.5% polyisobutylene, and (d) about 0.5% graphite (CH-6), a mixture of about (a) 98.5% RDX and (b) about 1.5% stearic acid (A-5), cyclotetramethylene tetranitramine (HMX), octogen-octahydro-1,3,5,7 tetranitro 1.3.5.7. tetrazocine, cyclic nitramine 2,4,6,8,10,12-hexanitro-2,4,6,8,10,12-hexaazaisowurtzitane (CL-20), 2,4,6,8,10,12-hexanitrohexaazaiso-wurtzitan (HNIW), 5-cyanotetrazol-pentaamine cobalt III perchlorate (CP), cyclotri-methylene trinitramine (RDX), triazidotrinitrobenzene (TATNB), tetracence, smokeless powder, black powder, boracitol, triamino trinitrobenzene (TATB), TATB/DATB mixtures, diphenylamine, triethylene glycol dinitrate (TEGDN), tertyl, N,N′-diethyl-N,N′-diphenylurea (ethyl centralite), trimethyleneolethane, diethyl phtalate trinitrate (E™), trinitroazetidine (TNAZ), sodium azide, nitrogen gas, potassium oxide, sodium oxide, silicon dioxide, alkaline silicate, salt, saltwater, ocean water, dead sea water, alkali, paints, inks or any combination thereof.

It is a further object of this invention to disclose an anaerobic fuel as described above, characterized by a form selected from the group consisting of flakes, grain, powder, spheres, gel, liquid, slurry, plastic, bars, ingots, capsules, ampoules, plastic disposal cartridge, special combined material cartridge, metal cartridges, discs or any combination thereof.

It is a further object of this invention to disclose a vehicle powered by a reciprocating engine as described above, wherein said vehicle is selected from the group consisting of cars, trucks, ships, marine vessels, submarines, aircraft, and spacecraft.

It is a further object of this invention to disclose an energy consuming mechanism, powered by a reciprocating engine as defined above, selected from the group consisting of electric power plants, pumps, generators, turbines, water purification plants, engines, and heat exchangers.

It is a further object of this invention to disclose a container for anaerobic fuel, fully armor-protected against light arms, characterized by a container-within-a-container arrangement and adapted to isolate said anaerobic fuel from heat, static electricity, sparks, lightning, fire, mechanical shock, and liquids.

It is a further object of this invention to disclose a container for anaerobic fuel as described above, wherein said container further comprises self-cooling and dry-air systems, adapted to keep said anaerobic fuel stored within at a temperature of between about −20° C. and about 35° C.

It is a further object of this invention to disclose a container for anaerobic fuel, wherein the container is storable in total vacuum conditions, allowing long-term storage of up to 20 years of the anaerobic fuel.

It is a further object of this invention to disclose a method for actuating a reciprocating engine by means of anaerobic fuel comprising the steps of (a) obtaining a reciprocating engine, said reciprocating engine comprising (i) at least one piston, said at least one piston adapted for reversible actuation in an N-stroke operation, where N is a positive integer; (ii) at least one cylinder adapted to accommodate said at least one piston; (iii) a crank in mechanical communication with said piston; (iv) a cylinder head adapted to accommodate said at least one piston and cylinder; (v) feeding means adapted to introduce fuel to said cylinder head at least once per piston stroke; said at least one piston adapted to reciprocate within said cylinder in an N-stroke operation where N is a positive integer; and (vi) at least one deflagration chamber in fluid communication with said cylinder head; (b) obtaining anaerobic fuel; (c) introducing said anaerobic fuel to said deflagration chamber at least once per stroke of said piston via said feeding means; and (d) igniting said anaerobic fuel contemporaneously with said piston reaching at least one predetermined location in said cylinder along each of said N strokes. It is in the essence of the invention wherein predetermined deflagration of said anaerobic fuel actuates said piston.

It is a further object of this invention to disclose such a method, additionally comprising the step of synchronizing the ignition step with the feeding step so that ignition occurs contemporaneously with the compression stroke of said reciprocating engine.

### BRIEF DESCRIPTION OF THE DRAWINGS AND FIGURES

In order to understand the invention and to see how it may be implemented in practice, a plurality of preferred embodiments will now be described, by way of non-limiting example only, with reference to the accompanying drawings, in which;

FIGS. 1A-B schematically illustrate, in lateral cross section, existing common four-stroke engines in the prior art;

FIG. 2 schematically represents, in lateral cross section, the new reciprocating engine;

FIG. 3 schematically represents, in lateral cross section, the new reciprocating engine without the piston;

FIG. 4 schematically represents, in lateral cross section, the new reciprocating engine with a piston made of high grade metal alloy and optional ceramic coating;

FIG. 5 schematically represents, in lateral cross section, the new reciprocating engine with a cooling liquid sleeve for the anaerobic fuel;

FIGS. 6A-C schematically represent, in lateral cross section, new cylinder head structures for the reciprocating engine;

FIGS. 7A-E schematically represent, in lateral cross section, new cylinder head structures for the reciprocating engine;

FIGS. 8A-C schematically represent, in lateral cross section, further new cylinder head structures for the reciprocating engine;

FIGS. 9A-C schematically represent, in lateral cross section, container types for the anaerobic fuel;

FIG. 10 schematically represents, in lateral cross section, the electronic control feeding system for the anaerobic fuel containers;

FIG. 11 schematically represents a front view of armored containers with a feeding system for the anaerobic fuel;

FIG. 12 schematically represents a back view of armored containers with a feeding system for the anaerobic fuel and with an air conditioning system and a CO₂ automatic fire-extinguishing system;

FIG. 13 schematically represents a top view of the anaerobic fuel container with an internal air distribution system;

FIG. 14 schematically represents storage arrangement of anaerobic fuel containers in a vehicle, e.g. a ship;

FIG. 15 schematically represents the exhaust gas redistribution and recycling system;

FIG. 16 schematically represents the dimensions of solid grains of the anaerobic fuel;

FIG. 17 illustrates graphs of pressure and heating inside the cylinder of the reciprocating engine that drives the piston using W.J—100™ fuel;

FIG. 18 illustrates graphs of pressure and heating inside the cylinder of the reciprocating engine that drives the piston using W.J—200™ fuel, and;

FIG. 19 schematically represents common shapes of W.J. Fuel™ grains.

### DETAILED DESCRIPTION OF THE PREFERRED EMBODIMENTS

The following specification taken in conjunction with the drawings sets forth the preferred embodiments of the present invention. The embodiments of the invention disclosed herein are the best modes contemplated by the inventor for carrying out his invention in a commercial environment, although it should be understood that various modifications can be accomplished within the parameters of the present invention.

The term ‘reciprocating engine’ refers hereinafter in a non-limiting manner to any engine that utilizes anaerobic fuel that does not require oxygen or other oxidizers to facilitate its deflagration, and that converts the pressure of gases produced by deflagration of the anaerobic fuel into a rotating motion of one or more crankshafts. The reciprocating engine may be of any utilizable configuration, e.g., common configurations that include inter alia the straight or inline configuration, the more compact V configuration, the wider but smoother flat or boxer configuration, an aircraft configuration, e.g., a configuration that can also adopt a radial configuration and less usual configurations, such as “H”, “U”, “X”, or “W” configurations, Wankel-type rotary configuration, etc. The term also denotes multiple-crankshaft configurations that do not necessarily need a cylinder head at all, but can instead have a piston at each end of the cylinder, called hereinafter the ‘opposed piston design’, e.g., Gnome rotary engine, characterized by a stationary crankshaft and a bank of radially arranged cylinders rotating around it, etc. According to one embodiment of the present invention, four-stroke cycle engines are provided, these being useful and cost effective engines characterized by the four cycles of ignition/deflagration, compression, power stroke, and exhaust. The aforesaid ‘reciprocating engine’ is also known by the term W.J.Engine™

The engine may be characterized by a separate and independent cooling system, consisting of suitable flowing matter, such as commercially available coolant, water, etc. Alternatively, the engine can be made of e.g., metal alloys, ceramics or composite materials especially adapted to operate at high temperatures and pressures, so that an additional cooling system is not required. In these systems, a commercially available engine can be upgraded to construct the aforesaid reciprocating engine by replacing members and mechanisms selected from the piston, the deflagration chamber, the cylinder, cylinder head or a combination thereof. Hence, by upgrading the engine capacity of reciprocating engines via use of anaerobic fuels, the engines may be with fewer pistons per engine or with smaller cylinders, but retaining the same capacity. It is also in the scope of the invention wherein the reciprocating engine is adapted to receive high-pressure gas, e.g., in the range of 140 bar or less to 155 bar or more.

It is in the scope of the invention wherein the reciprocating engine comprises a plurality of nozzles (see mechanism 719 for example), discs with shaped apertures, bores or holes, e.g., wherein at least a portion of said bores are perpendicular to the piston cross section and/or at least a portion of said bores are tilted in a predetermined angle with respect to the piston's main longitudinal axis, such that hot gases are directed towards a predetermined location in the cylinder head, such that, e.g., maximum pressure and maximum engine capacity is obtained.

It is in the scope of the invention wherein the piston seals are made of materials selected from polytetrafluoroethylene, polyurethanes, or silicone-base polymers. The bushing and wear rings may be made of commercially available materials such as Viton, Dlarin, or polyamide-base polymers. The rings may be made of graphite, metal or metal alloys, composite materials, ceramics or a combination thereof.

The term ‘valve’ refers hereinafter in a non-limiting manner to poppet valves that are used in most piston engines to open and close the intake and exhaust ports. The intake valve may be solely provided, if needed, with anaerobic fuel as defined in the present invention, feeding the reciprocating engine's piston cylinder. For example, the valve is designed as a flat disc of metal with an elongated rod (valve stem).

The term ‘cylinder’ refers hereinafter in a non-limiting manner to the space within which a piston travels in a reciprocating engine as defined above. The term also refers to multiple cylinders that are commonly arranged side by side in a common block. A cylinder block can be cast from, e.g., aluminum or cast iron. The cylinders may be lined with sleeves of harder metal or composite materials, or given a wear-resistant coating such as commercially available Nikasil. The cylinders may have wet liners. The cylinder block may sit, e.g., between the engine crankcase and the cylinder head, translating the reciprocating motion of the pistons into the rotating motion of the crankshaft via connecting rods attached to the pistons and crank. The piston is possibly sealed in each of the aforesaid cylinders by a series of metal rings that fit around the circumference of the piston in machined grooves. The cylinder's displacement is defined hereinafter as the area of the cylinder's cross-section (i.e., the bore) multiplied by the linear distance the piston travels within the cylinder (i.e., the stroke). This is called the ‘swept volume’ of a cylinder. The cylinder body may be at least partially made of ceramic plastics, sintered ceramic with beryllium or plastics, fine or nano-particles of ceramics with a particle diameter of e.g., 0.1 to 10 μm, metals, e.g., grey cast iron, aluminum, carbon, bronze or bronze alloy, or a combination thereof, and from high quality alloy. The cylinder may comprise at least one ceramic sleeve and/or inner coating which are adapted to retain the high pressure inside the cylinder and/or to be heat-resistant.

The term ‘piston’ refers hereinafter in a non-limiting manner to a sliding member that fits closely inside the bore of a cylinder, its purpose is either to change the volume enclosed by the cylinder, or to exert a force on a fluid inside the cylinder. According to one embodiment of the present invention, the piston is made and/or coated by ceramic materials, composite materials, or made by a special hard alloy or a combination thereof. The piston of the present invention is designed to hold the powerful pressure wave of the hot gases provided by the deflagration of the anaerobic fuel. The ceramic piston utilized in some embodiments of the reciprocating engines defined above is light weight, long-life, corrosion resistant, temperature resistant, shock resistant and characterized by increased strength and friction resistance. It is adapted to retain its structure under the high pressure created by the hot gases with nearly zero expansion of its dimensions, e.g., diameter or cross-section, due to the refractory nature and low coefficient of thermal expansion of the piston's composition.

The term ‘engine displacement’ is defined by the swept volume of a cylinder multiplied by the number of cylinders in the reciprocating engine.

The term ‘crankshaft’ refers hereinafter in a non-limiting manner to the part of the aforesaid engines that translates reciprocating linear piston motion into rotation. It typically connects to a flywheel, to reduce the pulsation characteristic of the four stroke cycle, or its parallel in a two-stroke cycle, and sometimes a torsional or vibrational damper at the opposite end, to reduce the torsion vibrations often caused along the length of the crankshaft by the cylinders furthest from the output end acting on the torsional elasticity of the metal. The crankshaft is possibly adapted to rotate either clockwise or counterclockwise or both.

The term ‘internal piston engine’ refers hereinafter in a non-limiting manner to a reciprocating engine as defined above containing a plurality of N cylinders, wherein N is any integer equal to or greater than one, e.g., 4, 8, 12 etc.

The term ‘ignition system’ refers hereinafter in a non-limiting manner to any electrical or compression heating system, outside flame and hot-tube system for ignition. According to one embodiment of the present invention, anaerobic fuel is fed into the cylinder or adjacent to it by a mechanical means. Hence for example, a plurality of chambers chosen from deflagration chambers, combustion chambers, or moderate blast chambers are provided in a pipe communication with the anaerobic fuel-based reciprocating engine. A predetermined measure of anaerobic fuel is fed to this engine as powder, cartridges, pellets, capsules, slurry etc, and ignited by the aforesaid ignition system through one or more of various mechanisms, e.g., heat, spark, electron beam, laser beam, ion beam or a combination thereof. As a result, commencing with the ignition, the anaerobic fuel deflagrates and a predetermined gas pressure is provided inside the cylinder.

The term ‘engine capacity’ refers hereinafter in a non-limiting manner to the displacement or swept volume by the pistons of the reciprocating engine. It is generally measured in liters or cubic inches for larger reciprocating engines and cubic centimeters for smaller engines. It is in the scope of the invention wherein the reciprocating engines and anaerobic fuels are useful for low rpm high capacity engines of e.g., about 100, 2500-60,000, 80,000, 150,000 HP or more.

The term ‘anaerobic fuels’ refers hereinafter in a non-limiting manner to a chemical composition being chemically or otherwise energetically providing for a deflagration driving of reciprocating engines. ‘Anaerobic fuels’ are also described the commercial terms W.J.Fuel™, W.J.Chimofuel™, and/or W.J.Explofuel™. The anaerobic fuel of the present invention does not require oxygen or other oxidizers to facilitate its deflagration. Anaerobic fuel of the present invention is adapted to be usable in a vacuum. Hence, it is in the scope of the invention wherein the anaerobic fuel of the present invention is especially yet not exclusively adapted to be utilized by any kind of vessel, underwater vessels, underwater energy plants, energy plants located at the top of mountains where the partial pressure of atmospheric oxygen is low, in space, etc. The anaerobic fuel is safe in operation and storage, and possibly, if required, comprises no traces of TNT or its derivatives.

The term ‘containers’ refers hereinafter in a non-limiting manner to the commercially available W.J.Container™.

The anaerobic fuel is easy to handle and store, especially within its especial containers. The anaerobic fuel is lightweight and compact. Being a very exothermic fuel, only small volumes of the same are required to achieve a powerful deflagration and/or moderate measured blast and/or moderate measured explosion. It is relatively inexpensive, especially in comparing the fuel cost per watt or watt-hour with oil-based fuels. The anaerobic fuel is a smokeless and environmentally friendly fuel. It can be utilized for any purpose where a reciprocating engine is of use, such as in power plants, heavy industry, light industry, any kind of propulsion machines, turbines, vehicles, such as cars and trucks, trains, any kind and type of ships, submarines, underwater units, commercial marine and submarine vessels, airplanes etc; pumps; generators; power plants; pumps of all types; heat exchangers, purification plants, chillers, heaters, heat exchangers and air conditioning stations, etc.

This anaerobic fuel is an ash free composition that leaves at most trace quantities of acids, NOₓ, and toxic derivatives thereof. Moreover, the anaerobic fuel is compliant with the IMO NOₓ emission regulations of the Annex VI of the MARPOL 73/78 convention.

The anaerobic fuel of the present invention is highly exothermic composition, and is commercialized in a pure state ready for immediate usage, wherein no pre-cleaning, pre-heating or other purification steps are required before utilizing the same.

It is in the scope of the present invention wherein the anaerobic fuel is selected from a group consisting inter alia a composition or compositions of sulfur, ammonium nitrate, ammonium picrate, aluminum powder, potassium chlorate, potassium nitrate (saltpeter), nitrocellulose, nitroglycerin pentaerythiotol tetranitrate (PETN), CGDN, 2,4,6 trinitrophenyl methylamine(tetryl) and any other booster propellants and or any other types of explosives, a mixture of about 97.5% RDX, about 1.5% calcium stearate, about 0.5% polyisobutylene, and about 0.5% graphite (CH-6), a mixture of about 98.5% RDX and about 1.5% stearic acid (A-5), cyclotetramethylene tetranitramine (HMX), octogen-octahydro-1,3,5,7 tetranitro 1.3.5.7. tetrazocine, cyclic nitramine 2,4,6,8,10,12-hexanitro-2,4,6,8,10,12-hexaazaisowurtzitane (CL-20), 2,4,6,8,10,12-hexanitrohexaazaisowurtzitan (HNIW), 5-cyanotetrazol-pentaamine cobalt III perchlorate (CP), cyclotrimethylene trinitramine (RDX), triazidotrinitrobenzene (TATNB), tetracence, smokeless powder, black powder, boracitol, triamino trinitrobenzene (TATB), TATB/DATB mixtures, diphenylamine, triethylene glycol dinitrate (TEGDN), tertyl, N,N′-diethyl-N,N′-diphenylurea (ethyl centralite), trimethyleneolethane, diethylphthalate trinitrate (E™), trinitroazetidine (TNAZ), sodium azide, nitrogen gas, potassium oxide, sodium oxide, silicone dioxide, alkaline silicate, salt, saltwater, ocean water, dead sea water, alkali, paints, inks or any combination thereof.

According to one embodiment of the present invention (W.J.Fuel 100A™), the anaerobic fuel comprises 98.8% nitrocellulose; 1% diphenylamine; and optionally, up to 0.2% color. Grain diameter is about 1.1 mm×1.2 mm×0.13 mm.

According to yet another embodiment of the present invention (W.J.Fuel 100A™), the anaerobic fuel comprises 97.8% nitrocellulose; 1% diphenylamine; optionally 1% potassium sulfate; and optionally up to 0.2% color. The grain diameter is about 1.1 mm×1.2 mm×0.13 mm.

According to yet another embodiment of the present invention (W.J.Fuel 200A™) the anaerobic fuel comprises 52.66% nitrocellulose; 42.47% nitroglycerin; 2.02% N,N′-diethyl-N,N′-diphenylurea (ethyl centralite); 2.65% diethylphthalate and optionally up to 0.2% color.

According to yet another embodiment of the present invention (W.J.Fuel 200™), the anaerobic fuel comprises of 52.71% nitrocellulose; 42.52% nitroglycerin; 2.02% N,N′-diethyl-N,N′-diphenylurea (ethyl centralite); 2.65% diethylphthalate and optionally, up to 0.1% color.

According to yet another embodiment of the present invention the anaerobic fuel is characterized by nitrogen content: 13.15%+/−0.005%; 132 DG C stability, Noml/g, max: 3.0; maximum alkalinity (as CaCO₃), 0.25%; fineness, ml 85 max; maximum ash, 0.4%; E/A (1:2) solubility, min 30%; maximum alcohol solubility, 4.0%; viscosity (2% acetone solution), 26.2-118 mm²/s; moisture, 20%-30%; packing: 100-105 kg net in metal drums.

According to yet another embodiment of the present invention the anaerobic fuel is characterized by diphenylamine content of 99.50%; Low boiling point 0.5%; High boiling point 0.5%; aniline 0.1%; freezing point 52.60° C.; reaction to water extract substance NETURAL; moisture 0.2% and alcohol insoluble substance 0.005%.

According to yet another embodiment of the present invention the anaerobic fuel is provided in various weights, energy power rates, and types, forms, colors and sizes selected in a non-limiting manner from flakes, powder, gel, liquid, slurry, plastic, flexible or hard materials, discs, bars, ingots, spheres, ovoids, parabola or hyperbola shapes, or any combination thereof. Moreover, angle shaped capsules, ampoules, plastic disposal cartridge, special combined material cartridge, metal cartridges, or any combination thereof may be used as will be clear to those skilled in the art.

The anaerobic fuel defined in the present invention, also known as W.J. Fuel™, is a brand name given to a family of energetic materials which have reducing and oxidizing moieties in the same composition. More specifically, the anaerobic fuels are organic molecules having a carbon skeleton and oxygen releasing groups in the same molecule. When initiated by a spark or by heat the molecules undergo an internal oxidation-reduction process (deflagration), yielding combustion products similar to those produced when organic materials are burned in open air. In most formulations, the oxygen-releasing moieties are nitro groups (—NO₂). Such formulations can deflagrate completely in closed spaces without the need of atmospheric oxygen. In the military industry such compounds are known as propellants, and are widely used in gun rounds and rockets as primers.

Schematically the reaction can be described as:

ΔFuel—(NO₂)ₙ→CO+CO₂+H₂O+N₂

The anaerobic fuel W.J.Fuel 100™ is a trade name of the simplest member of the family of the new energetic materials.

W.J.Fuel 100™ is 99% pure nitrocellulose stabilized by 1% diphenylamine Different additives, energetic or non-energetic, can be added the formulation, resulting in a family of products. W.J.fuel 100™ was chosen for the thermodynamic analysis. Most conclusions regarding this fuel will be relevant to other anaerobic fuel compositions.

Nitrocellulose-based anaerobic fuel is the main constituent of military propellants and various types of varnishes and lacquers. It is the main constituent and backbone of anaerobic fuel. It is produced in quantities in many locations in the world by a simple, straightforward reaction between cellulose and nitric acid. Cellulose is poly-glucose in which every glucose unit has three free hydroxyl groups that can be nitrated. Depending upon reaction conditions, any number of the hydroxyl groups can be nitrated, thus increasing the energy content of the fuel. The energy level, the extent of the nitration, is designated as a percentage of the nitrogen content. Fully nitrated nitrocellulose contains 14.14% N. W.J.Fuel 100™ is a plasticized nitrocellulose with 13.15% nitrogen content. The chemical equation for deflagration of a unit chain of W.J.Fuel 100™ (M.W=547.7) is presented in the following molecular scheme:

C₁₂H_{14.8}N_{5.15}O_{19.8}→10CO+2CO₂+5.5H₂O+1.9H₂+2.57N₂+traces(NO+CH₄)

Two major points in the equation should be emphasized: (i) No external oxygen is needed for the burning process; (ii) Although the fuel contains nitrogen, relatively little NOₓ is produced. The reason is that the oxygen of the nitro groups is used to oxidize the carbon and hydrogen and most of the nitrogen is released as N2. The adiabatic flame temperature of W.J.Fuel 100™ is 3034 K and the heat of reaction is 1034 cal/g. The average molecular weight of the burning gases is 24.3 and γ=Cₚ/Cᵥ=1.235. The relative amounts of the reaction products and some thermochemical data for W.J.Fuel 100™ are summarized in Table 1. For further comparison, the relevant data for the combustion of octane (as a representative of hydrocarbon fuel) is also included in Table 1.

TABLE 1
Combustion products and thermochemistry of
W.J.Fuel-100 ™ and Octane.

| | | |
|---|---|---|
| Property | Nitrocellulose | n-Octane + O₂ |

| | | | | |
|---|---|---|---|---|
| Enthalpy of Reaction | 1034 | cal/g. | 2542 | cal/g |
| Force | 1034 | joule/g. | 626 | joule/g. |
| Temperature of combustion | 3034 | K | 2277 | K |

| | | |
|---|---|---|
| CO | 51.12% | traces |
| CO₂ | 16.12% | 68.48% |
| H₂O | 18.07% | 31.52% |
| N₂ | 13.13% | — |
| H₂ | 0.69% | — |
| NO | traces | — |
| CH₄ | traces | — |
| Average MW of gases | 24.38 | 30.32 |
| CP/CV | 1.235 | 1.133 |
| No. of moles per 100 g | 4.07 | 3.30 |

The ability to extract useful work from the combustion reaction of material is often expressed in terms of the “force constant” of the material. In theory it is the ability of one gram of a propellant or a mixture of fuel and oxygen enclosed in a volume of one cubic centimeter to push a weightless, frictionless piston against atmospheric pressure until equilibrium of pressures is reached. Applying the universal gas equation: PV=nRT to the special case of n=1/M_{w} we get F=R×Tᵥ/M_{w}. Applying the formula to W.J Fuel 100™ we get: F_{WJ}=8.313×3034/24.38=1034.5 joule/g. This force value is much higher than that of the reaction of octane with oxygen, meaning that one can extract more work per unit weight from W.J.Fuel™ than a mixture of octane and oxygen.

The first law of thermodynamics states that the energy liberated in a chemical reaction is equal to the heat released in the reaction+work done by the system: dE=dQ−dW. If no work is done by the system, then dW=0 and ΔE=ΔQ. All the energy is converted into heat.

If the reaction takes place inside a piston, and the piston is moving against a constant pressure, then work is done and the equation takes the form dE=dQ−dW=dQ−PdV. Integration yields

$$Δ E = Q - P ln ( \frac{{V}_{2}}{{V}_{1}} )$$

The physical meaning of the equation is that the greater the ratio of V₂/V₁, the greater the work that can be extracted from the system.

In order to maximize work, the term P·ln(V₂/V₁) has to be maximized. More specifically, there is a need to maximize the term V₂/V₁ which, in piston terminology, means to maximize the compression ratio. Going back to the equation of deflagration of W.J.Fuel 100™:

C₁₂H_{14.8}N_{5.15O19.8}→10CO+2CO₂+5.5H₂O+1.9H₂+2.57N₂+traces(NO+CH₄)

548 g of solid W.J.Fuel 100™, which occupies a volume of 548/1.6=0.342 liters, produce 22 moles of gas upon deflagration which at S.T.P. will occupy a volume of 22×22.4 =493 liters.

As air and/or adiabatic compression are not required to ignite the fuel, we can devise a piston that can, theoretically, be compressed from volume of 493 liters to 0.342 liters, giving a compression ratio of 493/0.342=1440. Piston (or engine) efficiency is defined in terms of the “compression ratio,” the ratio of the volume of the piston before compression to the volume at the ignition point. In high octane car engines the compression ratio is about 8:1.

The thermodynamic efficiency of a piston is defined as

$$1 - {( \frac{1}{compression ratio} )}^{( γ - 1 )}$$

where γ=Cₚ/Cᵥ. If we assume that a piston is compressed to 1/1000 of its original volume, then for a compression ratio of 1000 the efficiency will be 1−( 1/1000)^{(1.235-1)}=1−0.197=0.803. Thus, the theoretical efficiency of W.J.Fuel 100™ is 80.3%. Such compression ratios would be practical in a newly designed engine because unlike the conventional gas oil engine, no adiabatic compression of air is needed in an engine operated by anaerobic fuel and no heat is generated during the compression stage.

An additional major advantage of using anaerobic fuel reciprocating engines is the ability to control the rate and timing of the pressure rise behind a moving piston. By knowing the burn rate of the energetic fuel we can design propellant grains with suitable geometry so that the pressure behind the moving piston will rise at a pre-designed rate to maximize the work of the piston.

In a traditional fuel engine the fuel-air mixture is compressed to its minimum volume. Upon ignition, the mixture reacts almost at once producing maximum pressure in the compressed piston. The piston then expands adiabatically to its final maximum volume, while the hot gases are exhausted. In thermodynamic terms, this is probably the most wasteful, irreversible work that a piston can do. The theoretical maximum work of a piston is a reversible process in which the force (pressure×area) inside the piston during expansion is always infinitesimally bigger than the force (mass, friction, external pressure) exerted on the outside of the piston. Such a theoretical process is unattainable, but with anaerobic fuels, one can come as close as possible to extracting maximum work. This can be done by designing the shape and size of the fuel grains. Solid fuel grains can be ignited only on the exposed area of each grain. If the burn rate of a grain is defined as the perpendicular receding surface of the grains (RB mm/sec), then the amount of fuel burnt per second can be calculated as Δm=Δ(RB×S×ρ), where S=external surface area and ρ=density. At constant burn rate and density, Δm=(RBρ)ΔS. This means that one can control the rate by which the mass of the fuel (Δm) is converted into gases (pressure) by designing the correct shape and size of grains.

This ability to pre-design the pressure rise within a piston may minimize the amount of fuel needed to move the piston. FIG. 20 illustrates possible shapes of W.J Fuel™ grains.

Octane was chosen as a representative hydrocarbon fuel in order to compare its thermodynamics and ability to perform work to that of W.J.Fuel—100™. The equation for the burning reaction of n-octane in air is

C₈H₁₈+12.5O₂ (air)→8CO₂+9H₂OΔH_{c}=−1307 kcal/mol

The adiabatic flame temperature of octane (when burned in air) is 2277 K. The heat of burning is 2542 cal/g for the combined system octane+oxygen. The average molecular weight of the products is 30.23 and C_{P}/C_{V}=1.05 (See Table 1). Calculating the “force constant” of octane using the formula: F=R×Tᵥ/M_{w} yields F_{octane}=(8.313)(2277/30.23)=626.1 joule/g. This is quite a low value when compared to the force of W.J.Fuel 100™. Dividing the force of W.J.Fuel 100™ by that of octane we get: 1034.5/626.1=1.6523. The meaning is that for equal amounts of fuels, W.J.Fuel 100™ can perform 65.23% more useful work than octane (not taking into account the differences in compressibility).

In order to completely consume 1 mole (114 g) of octane, one has to compress 12.5 moles of oxygen. The result is 17 moles of products. This is not a very good ratio of gas products to gas reactants. If one uses air, as in the case of all gas oil engines, then in addition to 12.5 moles of oxygen one has to add about 50 additional moles of nitrogen and argon. In today's pistons we compress 63.5 moles of reactants and after ignition obtain 67 moles of products. 67/63.5=1.055 is a very poor ratio. If we assume no change in temperature before and after the reaction, the increase in pressure after burning would be only 5.5%. The work that is extracted in such a process is the result of heating the products' gas rather than increasing the number of moles of gases in the reaction. Calculating the work efficiency of octane for a compression ratio of 8 we get 1−(⅛)^{1.133-1}=1−0.758=0.242. The conclusion from the comparison is that the major advantage of anaerobic fuels, e.g., W.J.Fuel 100™, over liquid hydrocarbon fuels is its ability to perform work without needing air and to reach piston compression ratios that are impossible to reach when using liquid hydrocarbons. The ratios of the work efficiencies of the two fuels multiplied by the ratio of the forces is (0.803/0.242)1.65=5.48, which may serve as a kind of index to how much less anaerobic fuel would be needed to perform the same work as a given quantity of octane.

Materials based on nitrocellulose belong to Hazard Classification Group 1.3C. This means that the fuel is inflammable but will not mass detonate. Improperly stored nitrocellulose-based materials are capable of self-ignition. Care must be taken to prevent such occurrences. When stored and packed in an appropriate manner, however, they can be safely shipped or transported by train or truck. Anaerobic fuels should be stored in drums in ambient temperature and a dry atmosphere. Under such conditions, the fuel can be stored for over 15 years.

Cellulose is the main component of higher plant cells and one of the most abundant organic compounds on earth. Billions of tons of cellulose are used every year by the paper and clothing industries. The main sources of cellulose are cotton, wood pulp, and acetobacteria. A mixture of concentrated nitric and sulfuric acid is used to nitrate the cellulose and produce the nitrate ester, known as nitrocellulose. The acids are recycled and reused for further nitration processes. Diphenylamine is a stabilizer for nitrocellulose and is added to nitrocellulose during production of anaerobic fuels in a concentration of 0.7-1.0%. It is a readily available and inexpensive chemical. Ethyl alcohol, ether and ethyl acetate, very common and widely used organic solvents, are used as media to plasticize nitrocellulose during the kneading and extrusion steps of W.J. Fuel™ production. In some energetic formulations additional energetic materials, such as diethyleneglycol dinitrate, triethyleneglycol dinitrate or RDX are added to nitrocellulose to increase energy.

Nitrocellulose is prepared by reactin a mixture of nitric acid and sulfuric acid with well-cleaned cotton linters or high-quality cellulose prepared from wood pulp. The concentration and the composition of the nitrating mixture determine the resulting degree of esterification, which is measured by determining the nitrogen content of the product. Thus, a family of anaerobic fuels can be prepared by varying the nitrogen content. The crude nitration product is first centrifuged in order to remove the bulk of the acid, after which it is stabilized by preliminary and final boiling operations. The spent acid is adjusted by the addition of concentrated nitric acid and anhydrous sulfuric acid and recycled for further nitration operations. The original form and external aspects of the cellulose remain unchanged during nitration. Subsequent boiling of the nitrocellulose under pressure finally yields a product with the desired viscosity level. The nitrated fibers are cut to a specific length in Hollanders or refiners. Nitrocellulose is transported in tightly closed drums protected against water and humidity or in carton drums with plastic bags inside.

Nitrocellulose, wetted by 20% of alcohol, is fed into a kneading machine. Werner Pfleiderer type kneaders are most commonly used. They consist of a bronze trough surrounded by a cooling jacket in which two powerful bronze stirrers in the form of sigma-shaped blades rotate in opposite directions, one twice as fast as the other. The kneaders in use are of varying capacity, and can hold charges ranging from 60 to 240 kg of dehydrated nitrocellulose (dry weight). After the kneader has been loaded its lid is closed and screwed down to the trough as tightly as possible. The stirrers are then set in motion; ether or ethyl acetate is fed through a conduit in the lid, as is an additional quantity of alcohol. Simultaneously the stabilizer is introduced into the kneader. Kneading requires 2.5-3 hr, although in exceptional cases 1-1.5 hr is enough. Since the mass heats up during kneading due to friction, cold water is fed into the cooling jacket of the kneading machine during the entire kneading period so that the temperature does not exceed 30° C. in order to prevent evaporation of the ether or ethyl acetate.

The environmental impact of the emitted gases from the anaerobic fuel defined above was studied, wherein the combustion or burning of nitrocellulose 13.25% is discussed as an example. The comparative study given for the monomer (MW=547.7) of the polymeric matter to the octane molecule indicates that in both cases the amount of CO₂ emitted depends on the weight per feed. Since for the same piston work output the nitrocellulose consumed is only 65.23% of the equivalent regular fuel, the operation of the anaerobic fuel will produce less CO₂. This will hold true even if the exhaust gas is treated either by combustion of the CO or by the water-gas shift reaction to produce CO₂ and H₂. The bulk of the nitrogen is emitted as N₂ with the highest estimate of NOₓ released without treatment being 0.19%. In a preferred embodiment of the invention, the gases are treated before release to either the atmosphere or water will have ˜200 ppm NOₓ, much lower than the allowed level for conventional engine emission. Both CO and NOₓ treatment units are commercially available and are proven technologies ready for application to any total emission level.

When kneading is finished, the ead is unscrewed and lifted. The stirrers are set to rotate in the opposite direction, and the trough is tilted by a special mechanism driven manually or mechanically. The dough falls from the trough into containers previously placed below. The containers loaded with the dough are hermetically closed and moved into the press area. The dough at this stage contains a considerable amount of solvent but is non-flammable and non-explosive. Only the solvent burns easily and only if there is access of sufficient air. After kneading, the dough is extruded through pre-designed dies and cut to size in a guillotine machine. The last stage is drying in an oven to remove the last traces of volatiles.

Anaerobic fuels for reciprocating engines are characterized by (i) high force constant for anaerobic fuel composition; (ii) very high work efficiency; (iii) small amounts of fuel for each piston stroke; (iv) no need for air intake systems to burn the fuel; (v) lower emission of reaction products, hence less pollution; (vi) no adiabatic air compression; (vii) reduced engine warming in the compression stages; (viii) simpler engine design; (ix) raw materials available with no political restrictions and (x) known production technologies.

According to yet another embodiment of the present invention, existing and working engines of all sizes and types can be upgraded to accommodate anaerobic fuel, e.g., by changing the cylinder head and removing or disconnecting the existing aerobic fuel systems, turbo systems etc, and replacing it with an automatic anaerobic fuel feeding system.

After the ignition and/or heating and subsequent deflagration, the gaseous products of deflagration are conducted through the cylinder head to the outlet manifold, and then optionally released through catalytic exhaust pipes or a catalytic converter, as well as possibly through silencers, mufflers, and a further heat engine designed to extract the remaining heat energy in the exhaust gas.

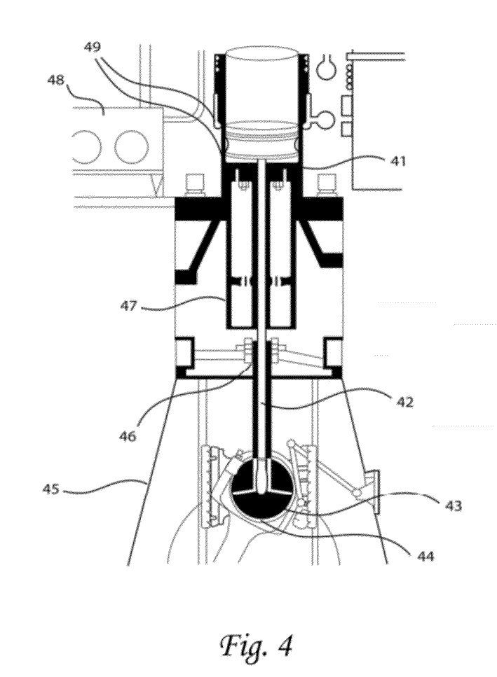

According to one embodiment of the present invention, the high-pressure gas forces the piston to its lower position as in FIG. 4 and then directed out through the exhaust valve, and/or valves and/or utilized in actuating mechanisms, additional auxiliary engines, e.g., secondary turbines, heat exchangers or generators located adjacent to or within a high pressure pipe in communication with the main reciprocating engine.

According to yet another embodiment of the present invention, a two-stroke cycle of an internal piston is provided. These reciprocating engines are possibly provided in a design arranged to start and run in either direction, e.g., clockwise or counter-clockwise. More specifically, such two-stoke low revolution reciprocating engines are useful for electric power plants, vessels and industry. Such two-stroke reciprocating engines are simple to construct and maintain, are 30 percent lighter, have fewer moving parts, do not need an expensive turbo system, pre-preparation for very costly heating boilers of heavy fuel oil, very expensive fuel systems, long fuel pipes, or valves and gauges in the control room.

According to yet another embodiment of the present invention, a two-stroke cycle of an internal piston reciprocating engine provides the most reliable dynamics. The best mode of such a two-stroke engine comprises a high grade metal and/or ceramic composition and/or any other combination of materials, alloys, polymers and carbon compositions such as will be obvious to one skilled in the art, with a very long life.

The piston, upon reaching the top position of the piston cycle (top dead center position, TDC), is actuated by ignition of the anaerobic fuel which deflagrates providing a predetermined measure of high-pressure gas that will actuate the piston and hence actuate the push rod and crankshaft to move diagonally, rotationally or horizontally, according to the specific engine design.

The downwards movement of the piston to its lowest position (bottom dead center position, BDC) allows most of the gas to be expelled optionally with the help of the piston that is moving toward its TDC position. This reversible movement of the piston and the exhaust of the pressured gasses is possibly initiated, monitored and controlled by an electronic control and electronic synchronized ignition system, or alternatively may be controlled and timed by mechanical means.

While the piston almost reaches its TDC position, the feeding/injecting system feeds/injects the anaerobic fuel to a distance in a special alloy groove in between the cylinder head space and the TDC position. The anaerobic fuel is hence ready for ignition and/or heating, adapted to stroke the piston downward. The anaerobic fuel is then ignited by a means selected inter alia from high voltage, high temperature, shock wave, deflagration, blast resistant spark plugs or other electrical means fitting into the cylinder head, e.g., by being effectively screwed into same, and operated under the supervision of a synchronized electronic control system and or mechanical control system.

According to another embodiment of the present invention the anaerobic fuel is ignited by sparks, electron beams, laser beams, UV light emitters, near-UV emitters, IR light emitters, either white or mono-chromatic visible light emitters, acoustic emitters, vibration emitters, radiation emitters or any combination thereof. Said emitters are possibly synchronized with the piston position and feeding system.

The piston of the reciprocating engine moves from BDC to TDC. When the piston is located adjacent to TDC, a high voltage coil releases a high voltage electrical current, spark or sparks, laser beam or other ignition means into the anaerobic fuel. This ignition step is synchronized by a computer electronic ignition system, or in an emergency, by a mechanical ignition system. According to one embodiment, the crankshaft reaches a predetermined location, e.g., 120°, and the exhaust port is opened so that pressurized gas is evacuated outside the cylinder. As the piston reaches the BDC it rises again, the exhaust ports are closed and another cycle starts.

In one embodiment of the invention, the crankshaft and cylinder are independently lubricated, and no mixing of lubricating oil in the upper cylinder head occurs while anaerobic fuel is fed. The newly reciprocating engine is provided here and below as an alternative to traditional diesel engines. According to this embodiment, the piston stands adjacent to the TDC while a predetermined ratio of anaerobic fuel is fed, loaded or pushed into an especially provided volume in between the cylinder head and piston head, at which point the anaerobic fuel is ignited and the deflagration, and or predetermined controlled measured moderated blast, and or predetermined controlled moderated explosion is obtained. The piston is hence actuated downward to the BDC, and then from the BDC to the TDC e.g. by action of the crankshaft.

According to another embodiment of the present invention, wherein the reciprocal engine further uses a cross head bearing which together with a special sliding pressure and oil seals on the piston rod allows the air path to be separated from the crankshaft while still using the piston movement as an air pump.

It is hence acknowledged that in a fully reciprocal engine's valve, two-stroke cycle, the exhaust valve is closed during the deflagration compression cycle and the piston moves down at the compression stroke. When the piston reaches a point adjacent to the BDC, the exhaust valves turn to their open configuration, and high pressure gases rush out of the cylinder. At this stage, the exhaust valve is closed.

According to another embodiment of the present invention, the reciprocal engine does not require inlet valves, since oxidizers are not required for the deflagration forming exothermic reaction.

Reciprocal engines are possible for modification of commercially available engines, e.g., Sulzer RTA48-B, RTflex50, RTA50, RTA52U, RT-flex58T-B, RTA58T-B, RT-flex60C, RTA62U-B, RT-flex96C, RTA96C etc., wherein for example, Sulzer RT-flex96C and RTA96C are of about 24,000 to 80,080 kW. Similarly, two stroke engines adapted from commercially available engines, such as MAN B&W engines, namely S60MC, S60MC-C, K80MC-S, L80MC, S80MC, K98MC-C Mk6, K98MC-C Mk7, and K98MC Mk6 engines and the like.

According to another embodiment of the present invention, the reciprocating engine overcomes the inefficiency and the pollution problems of gasoline based two-stroke engines, since no unburned fuel is provided. The feeding and storage systems are environmentally and ozone friendly and avoids release of dangerous gases to the atmosphere.

The reciprocating engines of the present invention, which comprise fewer moving mechanical parts, are characterized by quieter operation compared to the diesel engines known in the art.

Moreover, the reciprocating engine eliminates mixing of lubricant and fuel, hence reducing pollution. The reciprocating engine is reliable, light-weight, and characterized by reliable starting and ignition, especially in heavy diesel-like engines.

While in commercially available heavy diesel engines, the ignition, i.e., the very first compression of the diesel fuel, is subject to routine failure, the reciprocating engine disclosed in the present invention does not fail to start due to lack of initial compression or heat (which in other engines require external fixes like glow-plugs). Hence, in the reciprocating engine electrical starters and other igniting auxiliaries, as well as additional electrical power supplies, e.g., batteries etc. are unnecessary, as the engine may start running immediately.

Hence for example, the reciprocating engine starts to operate without any special, long, expensive and tedious preparations, such as cleaning the fuel from water contamination by means of expensive centrifugal system (such as the commercially available Alfa Laval products, for example). Moreover, no preheating of oil or fuel by expensive oil boilers is required.

Reciprocating engines utilizing anaerobic fuel eliminate the need for oxygen or oxidizers in routine operation and thus eliminate an entire set of valves and linkages, expensive turbo systems, filters, air filters, ventilation cooling systems to deliver fresh air constantly to the engine room, and thus reduce the manpower needed to maintain the above complicated expensive system, avoiding future damage to the main engine.

Thus, according to another embodiment of the present invention, diesel or heavy fuel heaters adapted to pre-heat intake of air for the operation of the diesel engine are not required.

According to the present invention, using the reciprocating engine there is no need for industrial compressors to allow sufficient air pressure for the first start of diesel engines or other large capacity combustion piston engines.

Similarly, using the reciprocating engine there is no need here for injection systems that are expensive to maintain, control systems, and associated array of fuel and air pipes, valves, gauges, etc., saving a lot of manpower.

The reciprocating engines and related technology reduce dependence on oil and gas sources and provide much cheaper energy substitutes. Import of oil products can thus significantly be reduced. Electricity costs are further significantly reduced.

The reliability of the reciprocating engine and newly combined technologies provides a period of about three years or more between overhauls, especially in the case of piston overhaul.

According to another embodiment of the present invention, costly storage of liquid oil products and hydrocarbon gases is reduced. The use of heavy fuel is hereby eliminated. Hence reciprocating engines are especially useful for use in vehicles where a light weight mass of efficient fuel is required and advantageous.

Hence for example, utilization of the reciprocating engine saves a significant measure of space which is currently required to store hundreds and thousands of fuel tanks in the bottom of vessels such as airplanes, ships and submarines, leaving the space available for loading additional profitable cargo.

According to yet another embodiment of the present invention, the reciprocating engine cylinder heads are characterized by various shapes and sizes, e.g. selected in a non-limiting manner from mortar-like, cannon-like or rocket-like configurations.

Storage of the anaerobic fuel is within secure containers that are well isolated against heat, static electricity, sparks, lightning, fire, shock waves, and which are provided with armored coating against light fire arms, RPG etc. A double hull ISO container, container-in-a-container arrangement is preferred. Standard ISO 20″ and 40″ as well a high cube ISO containers are preferably yet not exclusively of 20 ft or 40 ft. The container may be in a CO₂ environment and/or will be in communication with fire extinguishing systems. The anaerobic fuel is possibly accommodated in its container in an automatic manner, e.g., automatic loading/discharging system.

According to one embodiment of the present invention, the containers are arranged in a cascade or an array, where one container is in communication with at least one other, located e.g., beside, above, below, etc. Said array is either provided in series or in parallel, and is either 2D or 3D or any combination thereof.

The feeding is provided in any commercially available means known in the art, e.g., rail, conveyer belts, magazines, e.g., round magazines, pipes, conduits, snail-like or screw like apparatuses, possibly being continuously cooled, etc.

The reciprocating engine is a very compact and effective deflagration propagator, so that it requires only limited storage volume. Hence, refueling is required only after a respectively long period, e.g., up to 15-20 years or more.

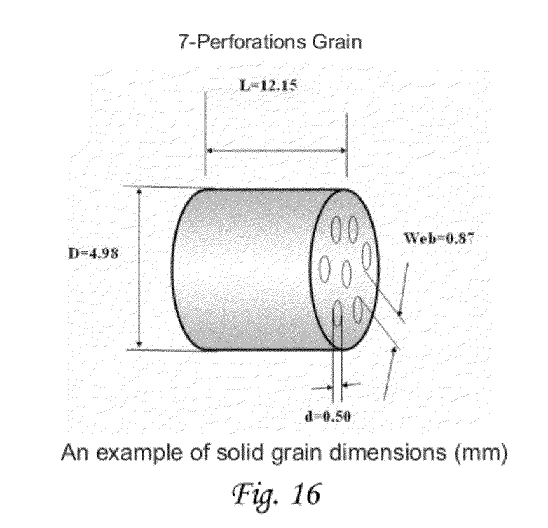

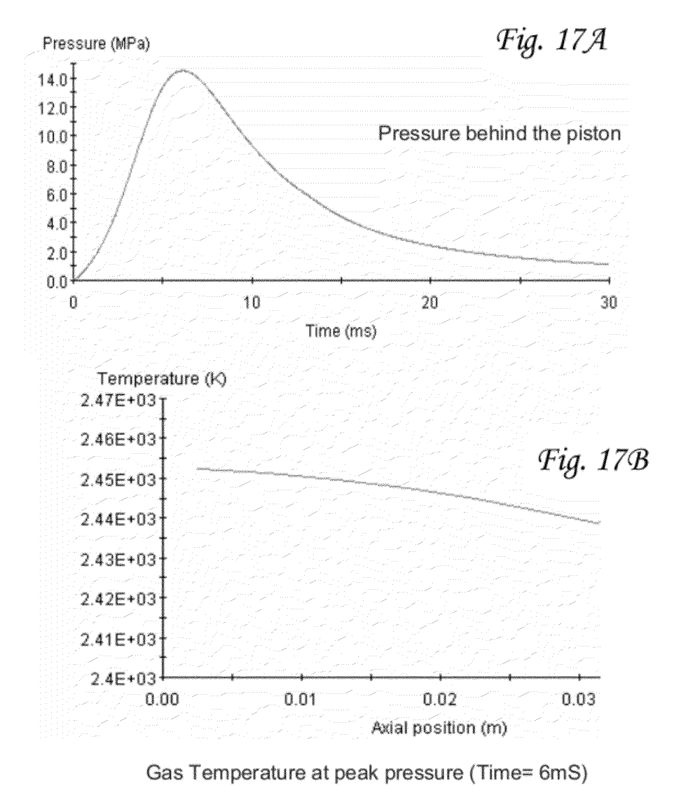

The efficiency of the reciprocating engine, utilizing anaerobic fuels was tested. Firstly, the minimal amount of propelling material needed to propel an engine piston (with the following characteristics) with pressure of 140-150 Bar was examined. The materials utilized in this experiment was as follows: piston weight 10000 kg, piston diameter 860 mm, and piston travel 2000 mm. The investigation was done by Ammunition Group IMI LTD (IL) by a means of numerical simulation, using two-phase fluid dynamics software, capable of dealing with solid combustion. The simulations are based on Internal Ballistics computational tools. These tools enable predictions with accuracy of 2-5%. The calculation was based on Transient 2 phase flow: The phases are grains (solid phase) and hot gases (gas phase). The software solves numerically momentum, mass and energy conservation for each phase. Special models were used for grain ignitions, combustion and regression, heat transfer and friction between the phases and equation of state. FIG. 16 illustrates the solid grain dimensions (mm).

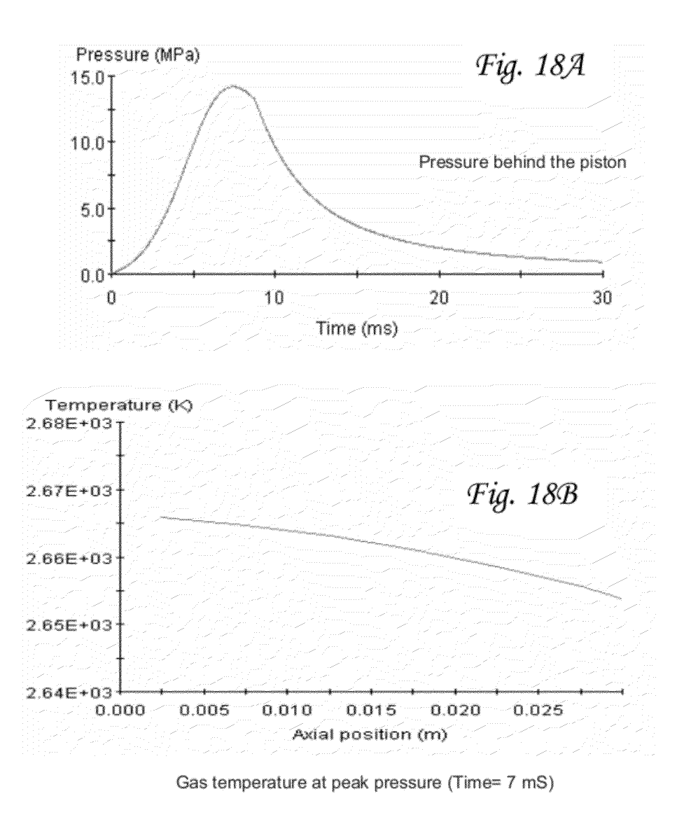

In one calculation, a sample of W.J.Fuel 100A™ was used. The fuel was provided in the form of a disk with diameter of 1.14 mm and height of 0.34 mm. The flame temperature was 3036 K, the confinement volume, 235 cc, the piston initial distance, 6.9 mm, the total volume, 4035 cm³, the fuel weight was 160 g for the final pressure of 145 Bar, and 170 g for the final pressure of 155 Bar. The combustion products were calculated to comprise CO, 46.0%; CO₂, 21.5%; H₂O, 16.9%; N₂, 12.9%; H₂, 0.7%, and others about 2.0%. FIG. 18A illustrates pressure behind the piston, and FIG. 18B illustrates the gas temperature at peak pressure (time=6 ms).

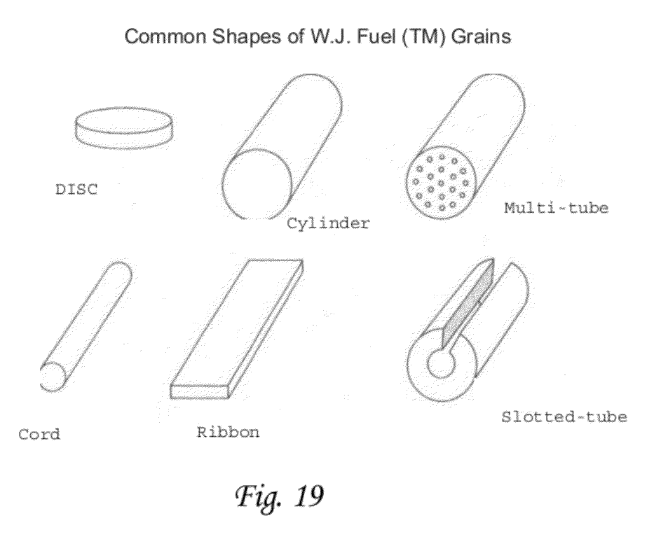

Another experiment was performed, utilizing W. J. Fuel 200A™ provided in the form of 1.2×1.2×0.13 mm flakes. The flame temperature was 3300 K, the confinement volume, 235 cm³, the piston initial distance, 6.9 mm, and the total volume, 4035 cm³. The fuel weight for a final pressure of 145 Bar was 105 g, and 115 g for a final pressure of 155 Bar. The combustion products were calculated to comprise CO, 37.6%; CO₂, 27.2%; H₂O, 19.2%; N₂, 14.9%; and others about 1.1%. FIG. 19A illustrates pressure behind the piston, and FIG. 19B illustrates Gas Temperature at peak pressure (time=7 ms).

The feasibility of piston propulsion by means of solid energetic materials has been demonstrated. The results of the numerical computations are shown in Table 2:

TABLE 2
Numerical computations for feasibility of piston
propulsion by solid energetic materials

| Pressure | | Weight |
|---|---|---|
| (BAR) | FUEL | (g) |
| 145 | W.JFUEL100A | 160 |
| 145 | W.JFUEL200A | 105 |
| 155 | W.JFUEL100A | 170 |
| 155 | W.JFUEL200A | 115 |

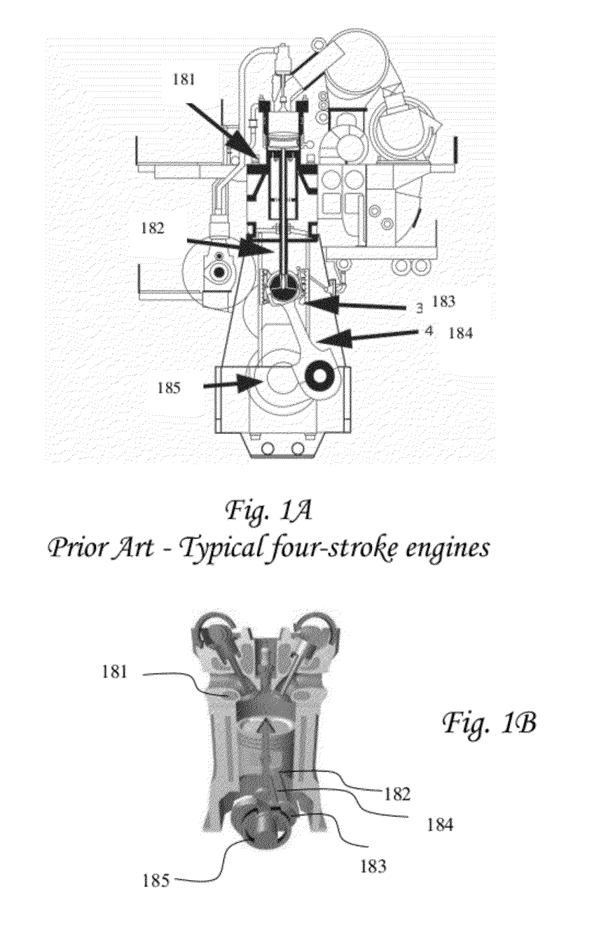

Reference is now made to FIGS. 1A-B representing a lateral cross section of typical four-stroke engines in the prior art, schematically illustrating piston (181), piston rod (182), crosshead (183), connecting rod (184), and crank (185).

Reference is now made to FIG. 2 representing a lateral cross section of one embodiment of the reciprocating engine disclosed in the present invention, schematically illustrating safety valve (200), heating plug/electric spark (201), exhaust valve system (202), cylinder head (203), strength piston with special gas mass pressure rings (204), service terrace (205), special seal (206) to prevent leakage of remaining gas from going down to the crank case (208), crank shaft (207), the main engine (209), push rod (210), piston cylinder (211), cooled piston cylinder (212), deflagration chamber (213), electronic control and automatic feeding/injecting system for anaerobic fuel (214), feeding rail (215), anaerobic fuel container (216) of a reciprocating engine, according to one embodiment of the present invention.

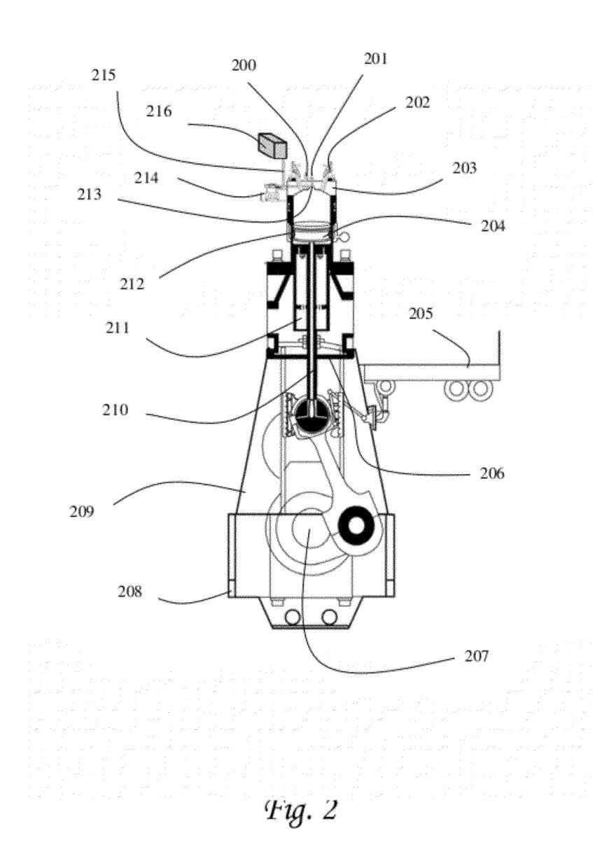

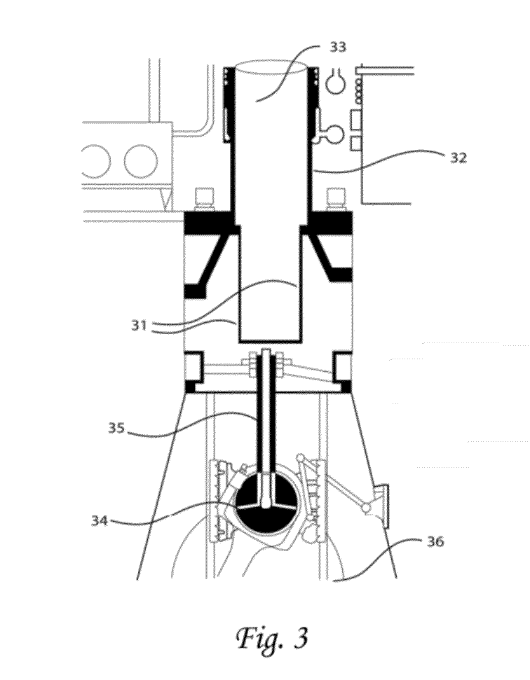

Reference is made now to FIG. 3 presenting sleeve (31), cooling liquid (32), cylinder (33), pistol rod bearing (34), piston push rod (35), and engine block (36) in a reciprocating engine, according to another embodiment of the present invention.

Reference is made now to FIG. 4 presenting a strengthened reciprocating engine according to another embodiment of the present invention, including a piston of high grade metal alloy, with optional ceramic coating (41), piston pushing rod—high graded metal (42), cross head bearing (43), piston rod bearings (44), engine housing (45), piston rod guider (46) coated cylinder sleeve (47) feeding electronic control system (48) and piston rings (49).

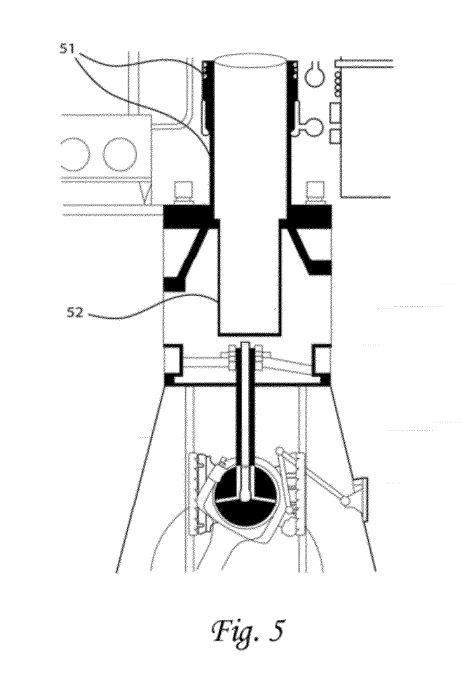

Reference is made now to FIG. 5, illustrating cooling liquid (51) and sleeve (52) of a reciprocating engine piston, according to another embodiment of the present invention.

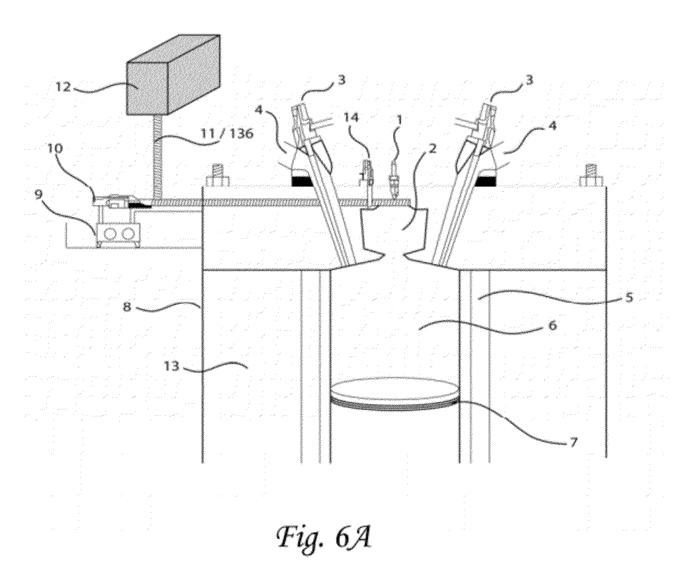

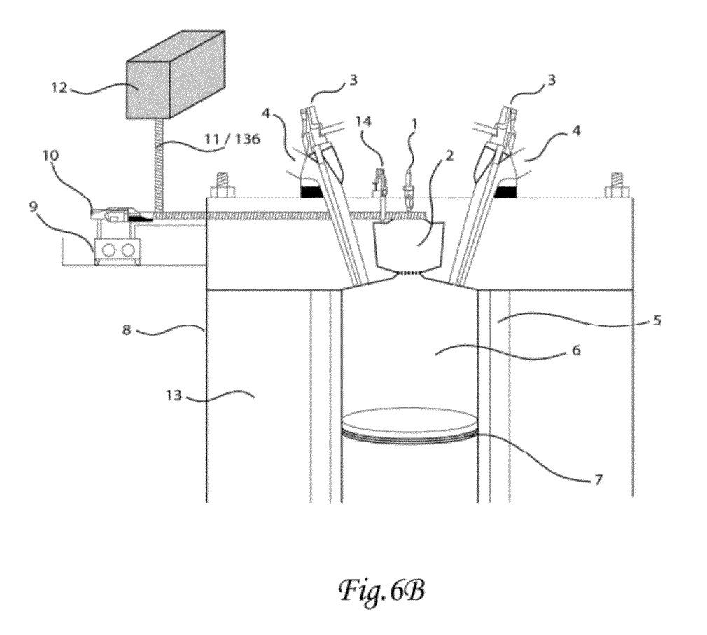

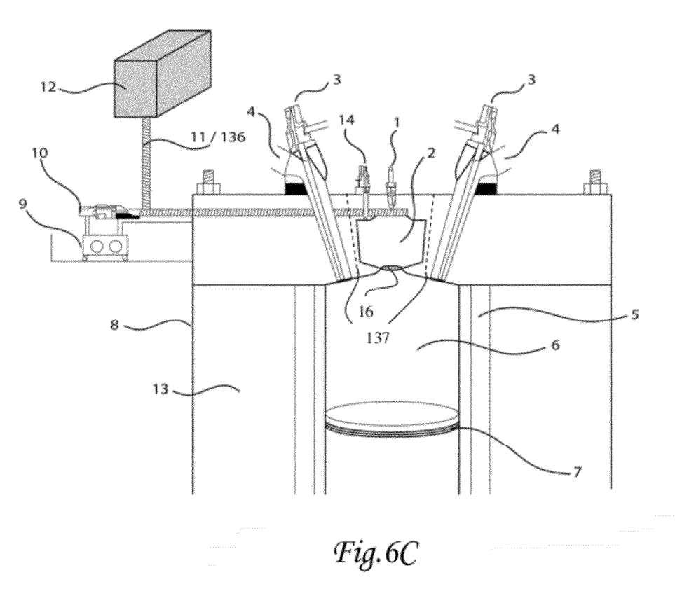

Reference is made now to FIGS. 6A-C, presenting lateral cross sections of reciprocating engines, according to one embodiment of the present invention, schematically illustrating a high voltage ignition plug (1), an enforced deflagration chamber (2) to which the anaerobic fuel is controllably fed from a container (12), via collecting (11) and feeding pipes or rail (13). Deflagration chamber (2) is a cannon-like arrangement. FIG. 6 also schematically represents the exhaust valve (3), exhaust pipe (4), reciprocating engine water cooling jacket (5), engine sleeve cylinder (6) piston (7), engine jacket (8), electronic hydraulic system (9), feeding, loading, and injecting system (10), providing direct feeding from storage container (11), storage container (12), feeding rail (13), safety valve feeding system control (14), and different types of gas nozzle directors (15 and 16), replaceable deflagration chamber (137). It is acknowledged in this respect that a plurality of blast chambers is possible in or adjacent to said cylinder.

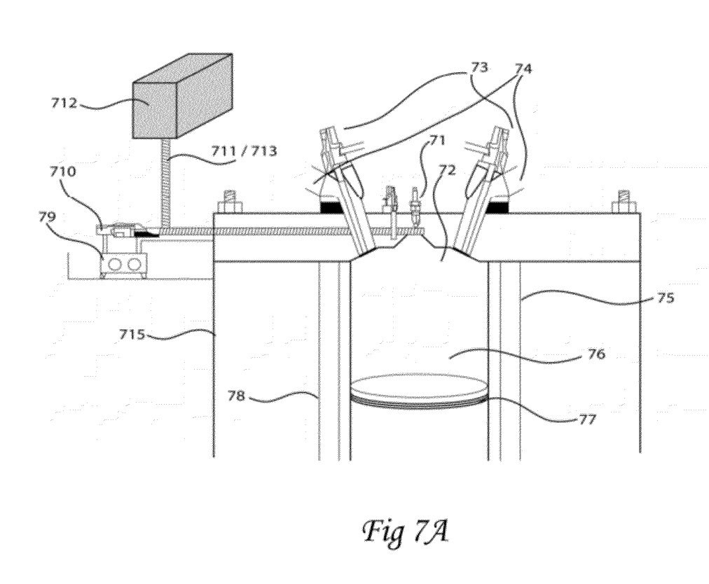

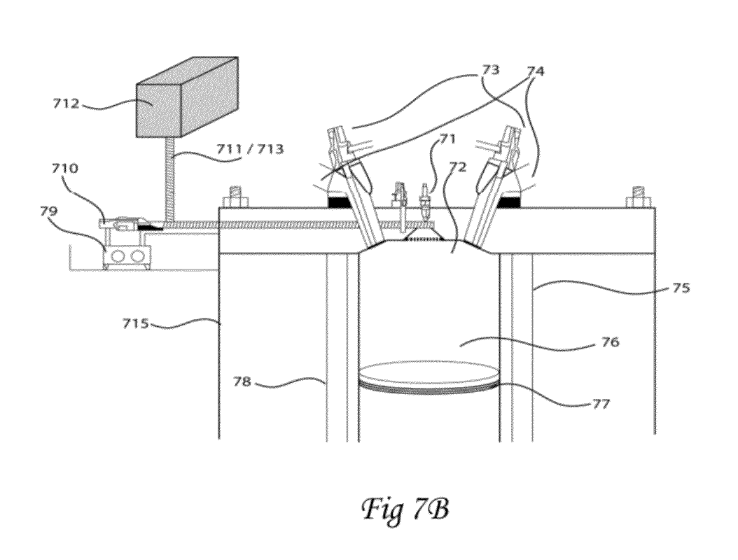

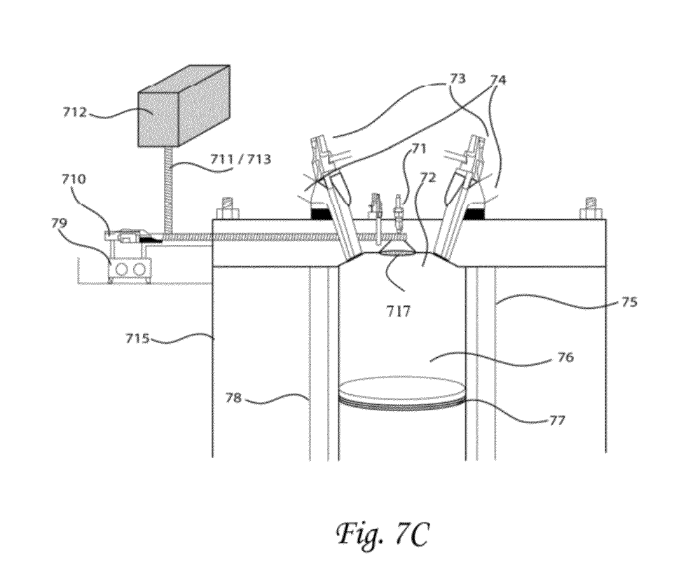

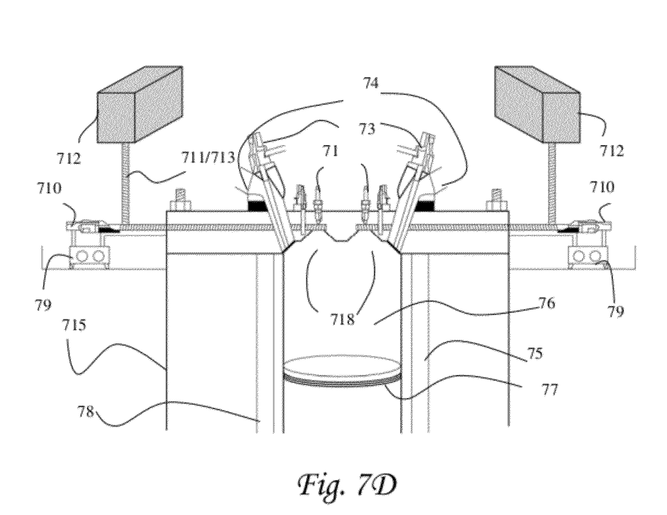

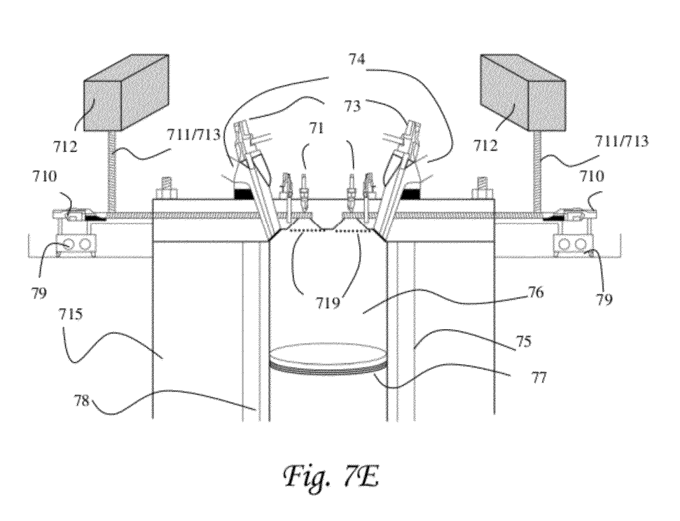

Reference is made now to FIGS. 7A-E presenting lateral cross sections of another embodiment of the present invention, showing ignition assembly (71), deflagration hull (72), exhaust valve assembly (73), exhaust pipe (74), cooling liquid (75), cylinder (76), piston (77), sleeve (78), electronic control feeding system (79), feeding assembly (710), collector (711), container (712), feeding rail (713), engine jacket (715), and different types of gas nozzle directors (716), direct nozzle for gas mass pressure (717), double deflagration chamber for double power (718), and double nozzles for direction of gas pressure mass for double deflagration chambers (719) of reciprocating engines.

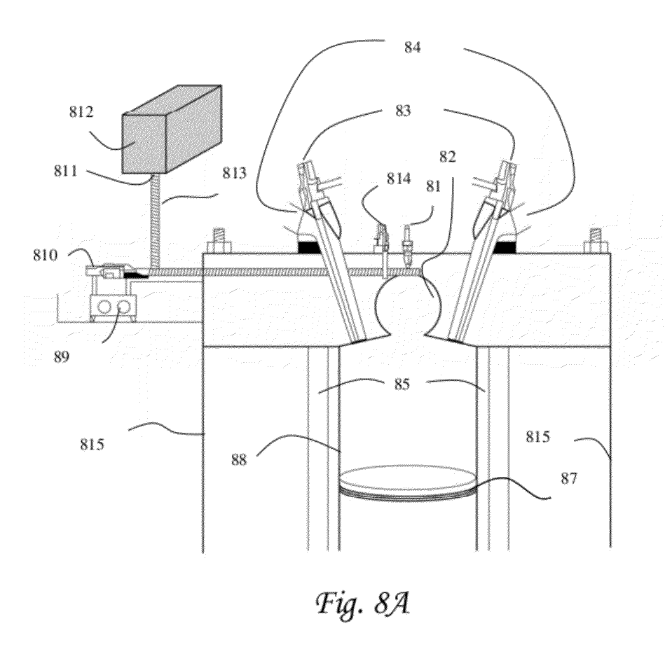

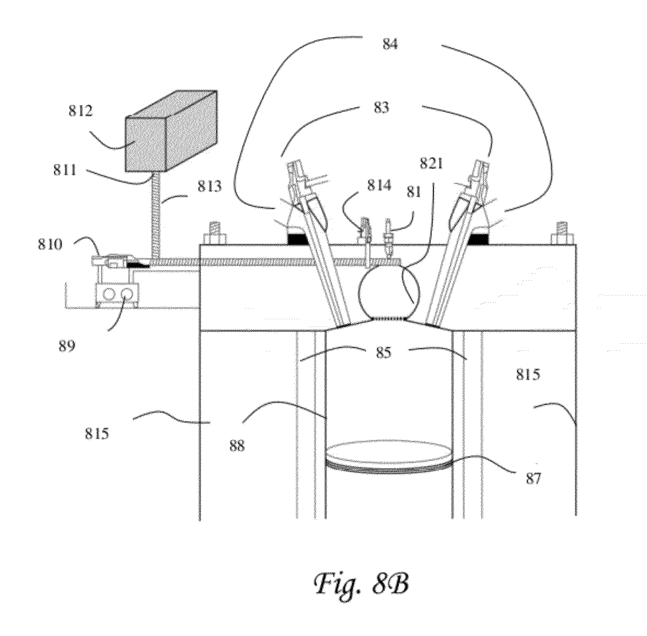

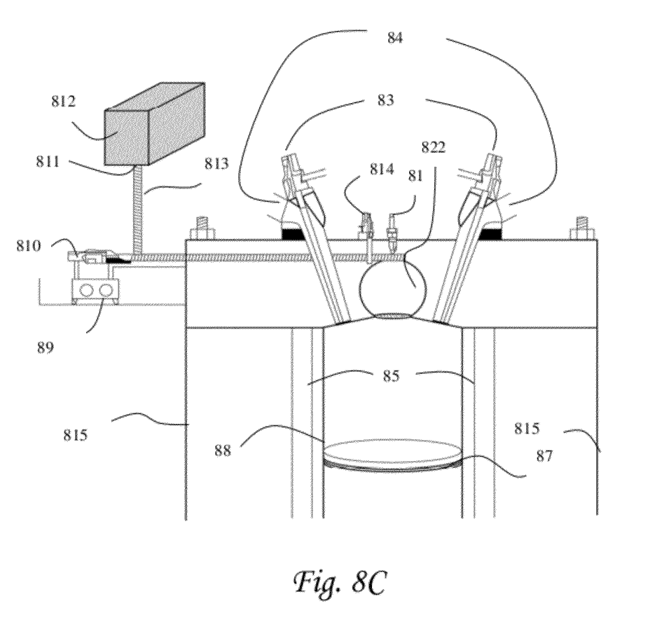

Reference is made now to FIGS. 8A-C, presenting another embodiment of the present invention, showing a deflagration chamber, wherein a high voltage sparking plug (81), enforced exploding chamber (82), nozzle for direction of gases to the top of the piston (821), nozzle for direction of gas (822), exhaust valve system of high grade metal (83), exhaust pipe (84), engine water cooling jacket (85), engine sleeve cylinder (86), strengthened piston with special comprehensive rings (87), engine sleeve (88), electronic hydraulic system (89), feeding loading and injection system (810), direct feeding from storage container (811), storage container (812), feeding rail (813), safety valve control system (814), and engine jacket (815).

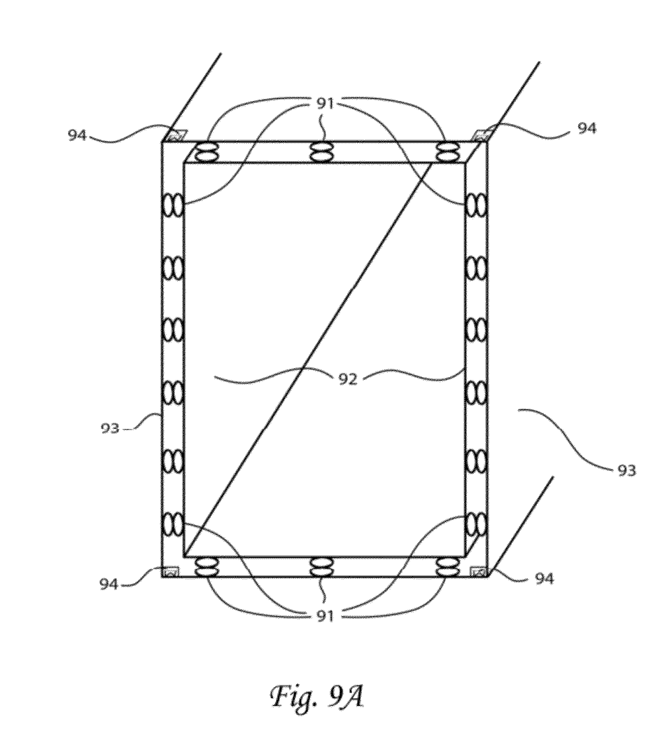

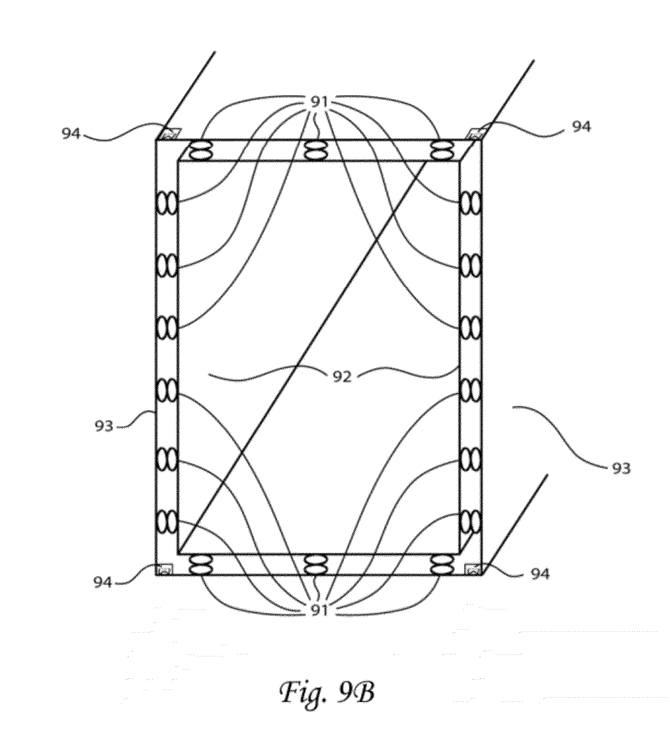

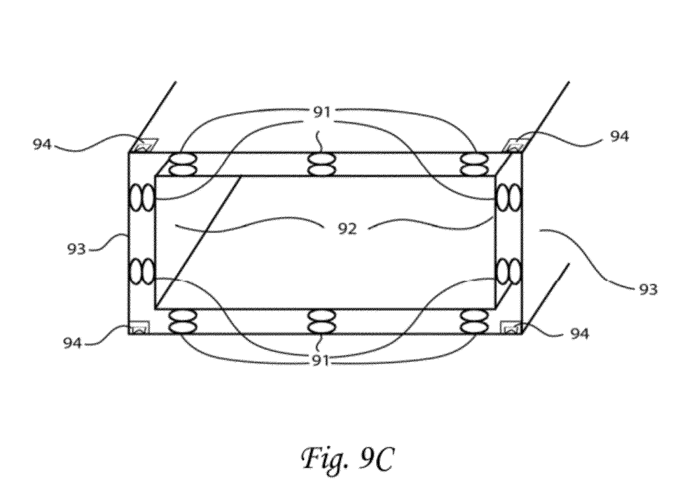

Reference is made now to FIGS. 9A-C, illustrating in lateral cross section a ceramic electronic isolator shock and lightning resistant (91), wood coated (92) metal container (93), safety lock, and anchoring means (94) according to another embodiment of the present invention.

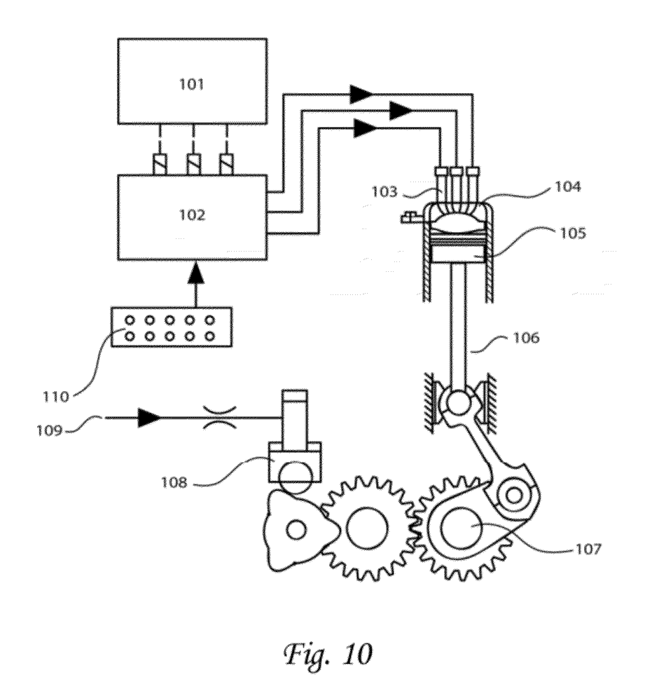

Reference is made now to FIG. 10 illustrating a reciprocating engine electronic control (101), volumetric fuel control (102), injection feeding and loading system (103), cylinder head (104), piston (105), piston rod (106), crankshaft (107), supply control system (108), piston position (109), electronic control system (110) of a reciprocating engine, according to another embodiment of the present invention.

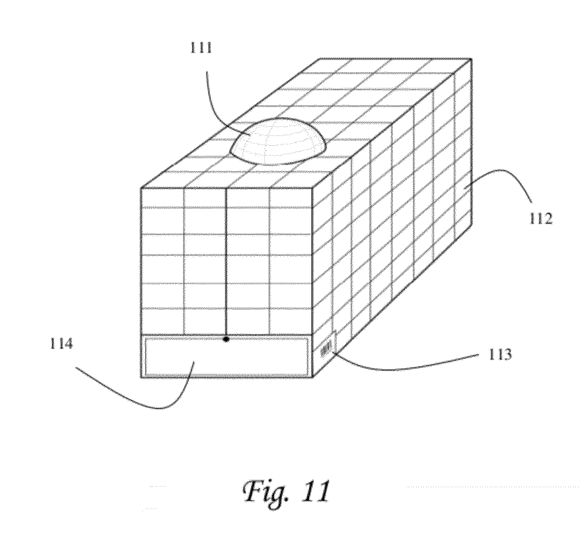

Reference is now made to FIG. 11, schematically illustrating a front view of anaerobic fuel container with satellite unit for locating container (111), armored coating to protect against light arms (112), bar code for control of transport (113) and feeding outlet (114), according to another embodiment of the present invention.

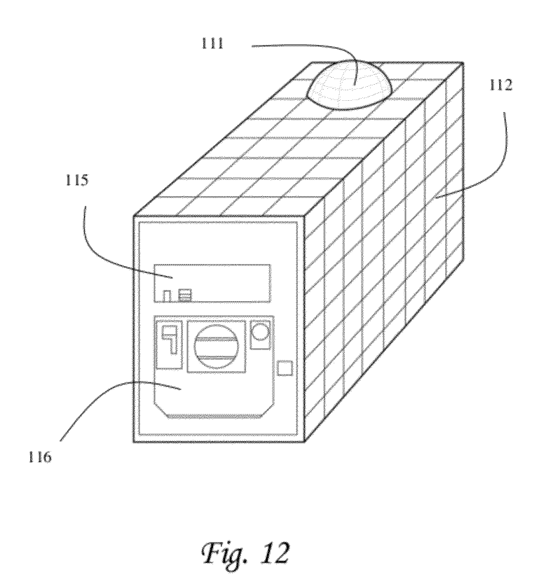

Reference is now made to FIG. 12, schematically illustrating a back view of anaerobic fuel container with armored coating (112), CO₂ fire and smoke detection and extinguishing unit (115), and a control center for air conditioning system (116), according to another embodiment of the present invention.

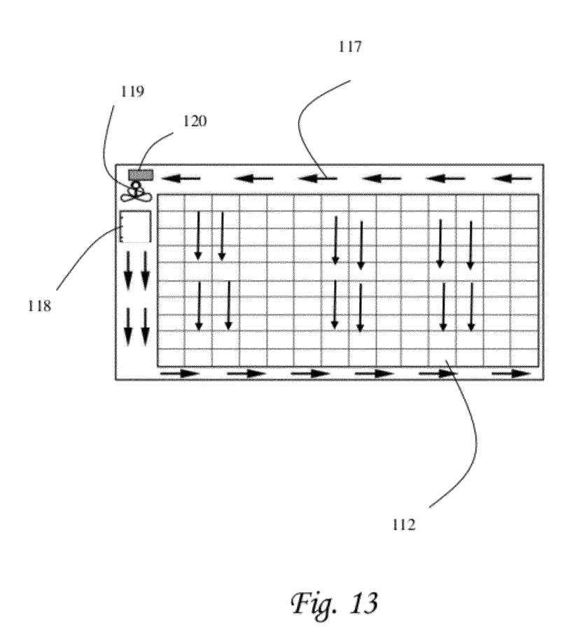

Reference is now made to FIG. 13 illustrating an anaerobic fuel container top view with armored coating (112), direction of air flow (117), with dehumidifier (118), fan (119), and vacuum pump (120), according to another embodiment of the present invention.

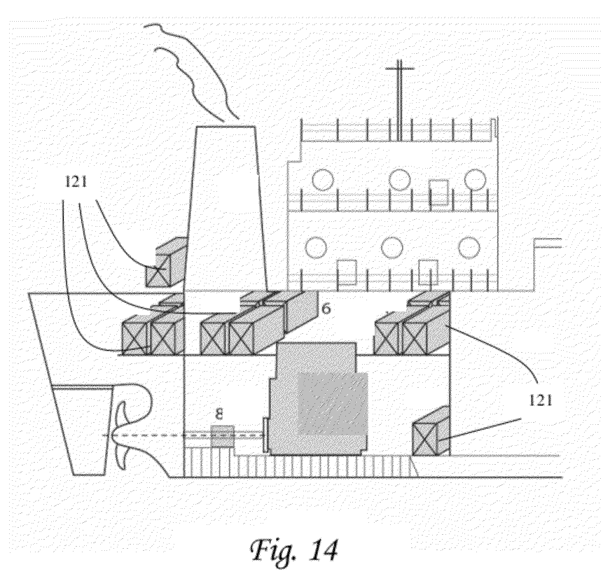

Reference is now made to FIG. 14 illustrating loading and arrangement of anaerobic fuel containers (121) on a ship, in another embodiment of the present invention.

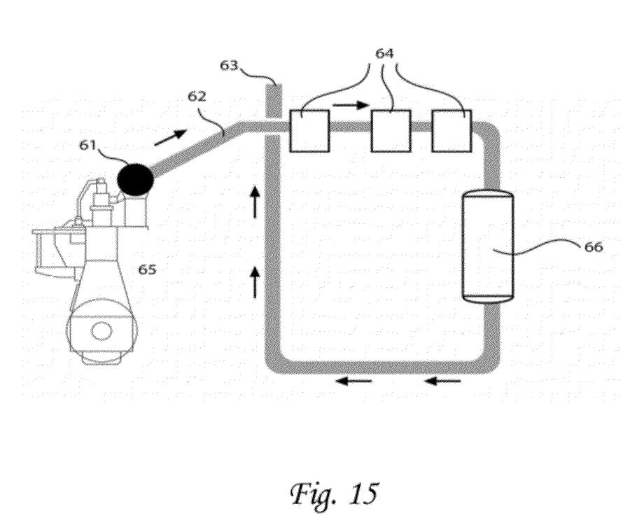

Reference is lastly made to FIG. 15, illustrating an exhaust gas receiver (61), high pressure gas pipe (62), exhaust funnel (63), generator sets and/or turbine sets (64), selective catalytic reactor, catalyst and/or silencer (65), and main engine (66) of a reciprocating engine according to another embodiment of the present invention.

1. An anaerobic fuel for reciprocating engines, said fuel selected from the group consisting of compositions of sulfur, ammonium nitrate, ammonium picrate, aluminum powder, potassium chlorate, potassium nitrate (saltpeter), nitrocellulose, nitroglycerin pentaerythiotol tetranitrate (PETN), CGDN, 2,4,6 trinitrophenyl methylamine(tetryl) and any other booster propellants and or any other types of explosives, a mixture containing (a) about 97.5% RDX, (b) about 1.5% calcium stearate, (c) about 0.5% polyisobutylene, and (d) about 0.5% graphite (CH-6), a mixture of about (a) 98.5% RDX and (b) about 1.5% stearic acid (A-5), cyclotetramethylene tetranitramine (HMX), octogen-octahydro-1,3,5,7 tetranitro 1.3.5.7. tetrazocine, cyclic nitramine 2,4,6,8,10,12-hexanitro-2,4,6,8,10,12-hexaazaisowurtzitane (CL-20), 2,4,6,8,10,12-hexanitrohexaazaiso-wurtzitan (HNIW), 5-cyanotetrazol-pentaamine cobalt III perchlorate (CP), cyclotri-methylene trinitramine (RDX), triazidotrinitrobenzene (TATNB), tetracence, smokeless powder, black powder, boracitol, triamino trinitrobenzene (TATB), TATB/DATB mixtures, diphenylamine, triethylene glycol dinitrate (TEGDN), tertyl, N,N′-diethyl-N,N′-diphenylurea (ethyl centralite), trimethyleneolethane, diethyl phtalate trinitrate (E™), trinitroazetidine (TNAZ), sodium azide, nitrogen gas, potassium oxide, sodium oxide, silicon dioxide, alkaline silicate, salt, saltwater, ocean water, dead sea water, alkali, paints, inks or any combination thereof.

2. The anaerobic fuel according to claim 1, characterized by a form selected from the group consisting of flakes, grain, powder, spheres, gel, liquid, slurry, plastic, bars, ingots, capsules, ampoules, plastic disposal cartridge, special combined material cartridge, metal cartridges, discs or any combination thereof.

3. The anaerobic fuel according to claim 1, adapted to power a vehicle powered by a reciprocating engine, wherein said vehicle is selected from the group consisting of cars, trucks, ships, marine vessels, submarines, aircraft, and spacecraft.

4. The anaerobic fuel according to claim 1, adapted to power an energy consuming mechanism, powered by a reciprocating engine, selected from the group consisting of electric power plants, pumps, generators, turbines, water purification plants, engines, and heat exchangers.

5. The anaerobic fuel according to claim 3, wherein said a reciprocating engine, comprising:
a. at least one piston, said at least one piston adapted for reversible actuation in an N-stroke operation, where N is a positive integer;
b. at least one cylinder adapted to accommodate said at least one piston;
c. a crank in mechanical communication with said piston;
d. a cylinder head adapted to accommodate said at least one piston and cylinder;
e. feeding means adapted to introduce fuel to said cylinder head at least once per piston stroke; and,
f. ignition means adapted to ignite said fuel in or adjacent to said cylinder head when said at least one piston is substantially in at least one predetermined location in said cylinder along each of said N strokes;
wherein said fuel is an anaerobic fuel and further wherein said piston is actuated by the pressure of gas produced by predetermined deflagration of said anaerobic fuel.

6. The anaerobic fuel according to claim 5, wherein said reciprocating engine additionally comprises controlling means, adapted to control the timing of said ignition according to a predetermined time protocol.

7. The anaerobic fuel according to claim 6, wherein the controlling means are selected from the group consisting of electronic means, mechanical means, hydraulic means, pneumatic means, sensors e.g., light sensor, pressure sensor, temperature sensor, chemical sensor, electronic sensors; valves, gages, solenoids, detectors, smoke detectors, processing means, real time based CPUs, displaying means, alarms, feed-backing means, recording means, transmitters, and any combination thereof.

8. The anaerobic fuel according to claim 3, wherein N=2.

9. The anaerobic fuel according to claim 3, wherein N=4.

10. The anaerobic fuel according to claim 3, wherein the igniting means are selected from a group consisting of heating plugs, sparkplugs, electron beams, lasers, visible light emitters, UV light emitters, IR light emitters, acoustic emitters, vibration emitters, radiation emitters, mechanical firing-pins or cocks, pressure inducing means, shock wave inducers, detonators, fire, heating means or heat wave emitters, oxidizers, acids, oils, mineral salts, igniting means in the gaseous, liquid or solid state, means for emission of a magnetic field, shim inducers, or any combination thereof.

11. The anaerobic fuel according to claim 3, wherein the engine type is selected from a group consisting of a rotary engine, horizontal engine, V-shaped, a line-shaped, star shaped, or engines with “H”, “U”, “X”, or “W” configurations.

12. The anaerobic fuel according to claim 3, wherein said cylinder head comprises at least one deflagration chamber, said at least one deflagration chamber adapted to accommodate at least a portion of said anaerobic fuel.

13. The anaerobic fuel according to claim 12, wherein said deflagration chamber is located within said reciprocating engine cylinder head.

14. The anaerobic fuel according to claim 12, wherein said deflagration chamber is located adjacent to said reciprocating engine cylinder head.

15. The anaerobic fuel according to claim 12, wherein said deflagration chamber is located outside of said cylinder head, and further wherein said deflagration chamber is in fluid communication with said cylinder head, said fluid communication means adapted to direct the flow of said gas produced by said predetermined deflagration from said deflagration chamber into said cylinder head.

16. The anaerobic fuel according to claim 12, wherein said igniting means provides at least 2 ignitions per piston stroke.

17. The anaerobic fuel according to claim 3, wherein said engine additionally comprises fluid communicating means adapted to direct exhaust gas from said reciprocating engine to at least one auxiliary chosen from the group consisting of a turbine, a heat exchanger, or a generator.

18. The anaerobic fuel according to claim 3, wherein the outer surface of said piston is at least partially made of materials selected from the group consisting of ceramic materials, metallic alloys, hard carbon, composite materials, ceramic plastics, sintered ceramic with beryllium or plastics matrices, fine or nano-particles of ceramics, metals, and any combination thereof.

19. The anaerobic fuel according to claim 3, wherein the outer surface of said cylinder is at least partially made of a substance chosen from the group consisting of ceramic materials, metallic alloys, composite materials, hard carbon, ceramic plastics, sintered ceramic with beryllium or plastic matrices, fine or nano-particles of ceramics, metals, and any combination thereof.

20. The anaerobic fuel according to claim 3, wherein the piston cylinder comprises a plurality of rings, especially pressure rings, lubricating rings, piston positioning direction rings, and further wherein at least one ring is at least partially made of materials selected from the group consisting of ceramic materials, metallic alloys, composite materials, ceramic plastics, sintered ceramic with beryllium, plastics matrices, commercially available Okolon combined materials, fine or nano-particles of ceramics with particle diameter of especially 0.1 to 1 μm, metals, and any combination thereof.
